(19) United States
(12) Patent Application Publication
(10) Pub. No.: US 2025/0326196 A1
(43) Pub. Date: Oct. 23, 2025

(54) APPARATUS AND METHOD FOR FORMING A TAPERED TRAY

(71) Applicant: INTERNATIONAL PAPER COMPANY, MEMPHIS, TN (US)

(72) Inventors: Ramiro Charles Del Bosque, Reedley, CA (US); Jay Frederic Bedwell, Visalia, CA (US)

(21) Appl. No.: 18/641,618

(22) Filed: Apr. 22, 2024

(51) Int. Cl. B31B 50/34; B31B 100/00; B31B 110/35

(52) U.S. Cl. CPC B31B 50/34; B31B 2100/0024; B31B 2110/35

(57) ABSTRACT

An apparatus including a mandrel assembly with a first side plate, a second side plate, first and second bars coupled to and extending between the first and second side plates, a first forming element pivotally coupled to the first bar and configured to rotate in a first direction by a first amount from a home position to a collapsed position, and a second forming element pivotally coupled to the second bar and configured to rotate in a second, opposite direction by a second amount from a home position to a collapsed position; and a folding station defining an opening that receives the mandrel assembly. Also provided is a method of forming a tapered tray from a blank.

### FIELD OF THE DISCLOSURE

This invention relates generally to packaging and, more particularly, to an apparatus and methods for forming a tapered tray from a blank.

### BACKGROUND

Trays fabricated from paperboard, e.g., corrugated fiberboard or corrugated paperboard, are often used to store and transport goods such as produce. Such trays may be formed from a blank of sheet material (hereinafter “blank”), which is folded and includes opposing tapered sides. Conventional tray-forming equipment, which uses a mandrel assembly that advances into, and withdraws from, a folding station to form the tray from the blank, is frequently specific to a particular blank and tray and relies, in part, on the angle at which the mandrel assembly enters the folding station to control a degree of taper of the finished tray. Thus, using a blank with a different thickness or forming a tapered tray having a different degree of taper, a different depth, etc. would typically require altering the configuration of the equipment and/or changing out one or more components. In addition, the degree of taper on one side of the finished tray is often different from the degree of taper on the opposing side. Furthermore, conventional equipment frequently requires the use of additional components such as “flap pushers” to control the degree of taper and to complete the tray. These additional components can wear out over time and require replacement, increasing the amount of down time and reducing efficiency.

### SUMMARY

In accordance with a first aspect, an apparatus is provided, which includes a mandrel assembly and a folding station defining an opening that receives the mandrel assembly. The mandrel assembly comprises: a first side plate; a second side plate spaced apart from the first side plate; first and second bars coupled to and extending between the first and second side plates, the second bar being spaced apart from the first bar; a first forming element pivotally coupled to the first bar and configured to rotate in a first direction by a first amount from a home position to a collapsed position; and a second forming element pivotally coupled to the second bar and configured to rotate in a second direction by a second amount from a home position to a collapsed position, in which the second direction is opposite the first direction.

The second amount may be substantially equal to the first amount.

The first forming element may comprise a first main body and at least one first forming section that extends beyond the first main body, and the second forming element may comprise a second main body and at least one second forming section that extends beyond the second main body. When the first and second forming elements are in the home position, front edges of the first and second side plates and the at least one first and second forming sections may collectively define a first footprint, and the opening defined by the folding station may comprise dimensions corresponding to the first footprint. When the first and second forming elements are in the collapsed position, front edges of the first and second side plates and the at least one first and second forming sections may collectively define a second footprint that is smaller than the first footprint.

The at least one first and second forming sections may extend beyond respective upper and lower edges of the first and second side plates by a first distance when the first and second forming elements are in the home position, and the at least one first and second forming sections may extend beyond the respective upper and lower edges of the first and second side plates by a second distance when the first and second forming elements are in the collapsed position, the second distance being less than the first distance.

The at least one first forming section may comprise a first substantially planar outer edge and the at least one second forming section may comprise a second substantially planar outer edge. When the first and second outer forming elements are in the home position, the first and second substantially planar outer edges may be substantially parallel with each other.

The mandrel assembly may further comprise at least one first biasing element configured to bias the first forming element toward the home position, and at least one second biasing element configured to bias the second forming element toward the home position.

The folding station may comprise: at least one first deck section defining a first deck plane; at least one second deck section spaced apart from the at least one first deck section and defining a second deck plane parallel with the first deck plane, in which the first and second deck planes extend parallel to a longitudinal axis of the first and second forming elements; at least one first horizontal roller associated with the at least one first deck section such that the at least one first horizontal roller extends beyond the first deck plane and is configured to contact the first forming element, and at least one second horizontal roller associated with the at least one second deck section such that the at least one second horizontal roller extends beyond the second deck plane and is configured to contact the second forming element, in which the at least one first and second horizontal roller each have a rotational axis parallel to the respective first and second deck planes.

The first side plate may comprise a first front edge and the second side plate may comprise a second front edge, in which the first and second front edges are substantially perpendicular to the first and second deck planes.

The at least one first horizontal roller may be movably mounted with respect to the at least one first deck section such that the at least one first horizontal roller is configured to deflect in a direction that is substantially perpendicular to the first deck plane, and the at least one second horizontal roller may be movably mounted with respect to the at least one second deck section such that the at least one second horizontal roller is configured to deflect in a direction that is substantially perpendicular to the second deck plane.

The folding station may comprise at least one first vertical roller and at least one second vertical roller, in which the at least one second vertical roller is spaced apart from the at least one first vertical roller and in which a rotational axis of the at least one first and second vertical rollers is perpendicular to a longitudinal axis of the first and second forming elements.

The apparatus may further comprise an actuator coupled to the mandrel assembly and configured to move the mandrel assembly relative to the folding station.

In accordance with a second aspect, a method of forming a tapered tray from a blank is provided, in which the blank comprises a bottom panel and first, second, third, and fourth side panels coupled to the bottom panel and the method comprises: providing a mandrel assembly comprising a first forming element configured to rotate in a first direction and a second forming element configured to rotate in a second direction opposite the first direction, in which the mandrel assembly comprises a first footprint substantially corresponding to at least one of a length and a width of the bottom panel; advancing the mandrel assembly to a first position such that the mandrel assembly engages the bottom panel of the blank and moves the blank toward a folding station; advancing the mandrel assembly to a second position within the folding station to fold the first and second side panels inward toward each other to a first folded position, in which the first and second side panels are substantially perpendicular to the bottom panel in the first folded position; advancing the mandrel assembly to a third position within the folding station to fold the first and second side panels further inward to a second folded position; advancing the mandrel assembly to a fourth position within the folding station to couple the third and fourth side panels to the first and second side panels to form the tapered tray; and withdrawing the mandrel assembly from the tapered tray, in which the first and second forming elements rotate in the respective first and second directions as the mandrel assembly withdraws, such that the mandrel assembly comprises a second footprint that is smaller than the first footprint.

An opening of the tapered tray may be defined by outer edges of the first, second, third, and fourth side panels and comprises a length and a width, in which one of the length or the width of the opening is less than the length or the width of the bottom panel and in which a length and a width of the second footprint of the mandrel substantially corresponds to, or is less than, the length and width of the opening.

Advancing the mandrel assembly to the second position may comprise contacting the first side panel with at least one first deck section of the folding station and contacting the second side panel with at least one second deck section of the folding station such that the first and second side panels fold inward to the first folded position.

The folding station may further comprise at least one first horizontal roller associated with the at least one first deck section and extending beyond a first deck plane defined by the at least one first deck section, and at least one second horizontal roller associated with the at least one second deck section and extending beyond a second deck plane defined by the at least one second deck section, in which the first and second deck planes extend parallel to longitudinal axes of the first and second forming elements. Advancing the mandrel assembly to the third position may comprise contacting the first side panel with the at least one first horizontal roller and contacting the second side panel with the at least one second horizontal roller, such that the first and second side panels fold inward to the second folded position.

The mandrel assembly may further comprise a first side plate and a second side plate, the second side plate being spaced apart from the first side plate, in which the first and second forming elements extend between the first and second side plates. When the mandrel assembly advances into and withdraws from the folding station, front edges of the first and second side plates may be substantially perpendicular to the first and second deck planes.

When the first and second side panels are in the second folded position, the first side panel may be positioned at a first inner angle of less than 90 degrees with respect to the bottom panel, and the second side panel may be positioned at a second inner angle of less than 90 degrees with respect to the bottom panel. The first and second inner angles may be substantially equal. The first and second inner angles may be between about 85 and 87 degrees.

### BRIEF DESCRIPTION OF THE DRAWINGS

While the specification concludes with claims particularly pointing out and distinctly claiming the subject matter of the present disclosure, it is believed that the subject matter will be better understood from the following description in conjunction with the accompanying Drawing Figures, in which like reference numerals identify like elements, and wherein:

FIG. 1 is a plan view of an exemplary blank for forming a tray, in accordance with the present disclosure.

FIG. 2A is a perspective view of a tapered tray, in accordance with the present disclosure.

FIGS. 2B and 2C are side views of the tapered tray of FIG. 2A taken along respective view lines 2B-2B and 2C-2C.

FIG. 3 is a back perspective view of an exemplary apparatus for forming a tapered tray, in accordance with the present disclosure.

FIG. 4 is a detailed perspective view of a hopper assembly of the apparatus of FIG. 3.

FIG. 5A is a back perspective view of a portion of an exemplary folding station of the apparatus of FIG. 3.

FIG. 5B is a detailed front view of a portion of the folding station of FIG. 5A.

FIGS. 5C-5F are detailed perspective views of portions of the folding station of FIG. 5A.

FIG. 6 is a back perspective view of a track assembly of the apparatus of FIG. 3.

FIG. 7 is a front view of an exemplary mandrel assembly of the apparatus of FIG. 3.

FIG. 8 is a side view of an exemplary mandrel assembly that is similar to the mandrel assembly of FIG. 7.

FIG. 9A is a back, perspective view of the mandrel assembly of FIG. 8.

FIG. 9B is a detailed view of a portion of the mandrel assembly of FIG. 9A.

FIG. 10 is a partially exploded view of a portion of the mandrel assembly of FIG. 8.

FIGS. 11A, 11B, 12A, and 12B are side views of a portion of the mandrel assembly of FIG. 8, in which an upper and a lower forming element are in a home position (FIGS. 11A and 12A) and a collapsed position (FIGS. 11B and 12B).

FIG. 13 is a front view of the mandrel assembly of FIG. 7, in which the upper and lower forming elements are in a collapsed position.

FIG. 14 is a front view of the mandrel assembly of FIG. 8 and the folding station of FIGS. 5A-5F, in which the mandrel assembly is advanced partially into the folding station.

FIG. 15 is a front view of a further exemplary mandrel assembly and folding station, in accordance with the present disclosure, in which the mandrel assembly is in a withdrawn position.

FIG. 16 is a back perspective view of the mandrel assembly of FIG. 7 and the folding station of FIGS. 5A-5F, with the mandrel assembly in a partially withdrawn position.

FIG. 17 is a back perspective view of the mandrel assembly and folding station of FIG. 16, in which the mandrel assembly is advanced forward to engage a blank.

FIGS. 18 and 19 are back perspective views of the mandrel assembly and folding station of FIG. 17 as the mandrel assembly advances further forward.

FIG. 19A is a simplified cross-sectional view taken through a center of the mandrel assembly and folding station of FIG. 19.

FIG. 20 is a back perspective view of the mandrel assembly and folding station of FIG. 19, in which the mandrel assembly advances further forward.

FIG. 20A is a simplified cross-sectional view similar to FIG. 19A taken through the center of the mandrel assembly and folding station of FIG. 20.

FIG. 21 is a front perspective view of the mandrel assembly and folding station of FIG. 20, in which the mandrel advances toward a fully extended position.

FIG. 22 is a front perspective view of the mandrel assembly and folding station of FIG. 21, in which the mandrel has advanced fully forward to form a tapered tray and begins to withdraw.

FIG. 22A is a simplified cross-sectional view similar to FIG. 19A taken through the center of the mandrel assembly and folding station of FIG. 22.

### DETAILED DESCRIPTION

In the following detailed description of the preferred embodiments, reference is made to the accompanying drawings that form a part hereof, and in which is shown by way of illustration, and not by way of limitation, specific preferred embodiments in which the subject matter of this disclosure may be practiced. It is to be understood that other embodiments may be utilized and that changes may be made without departing from the spirit and scope of the present disclosure.

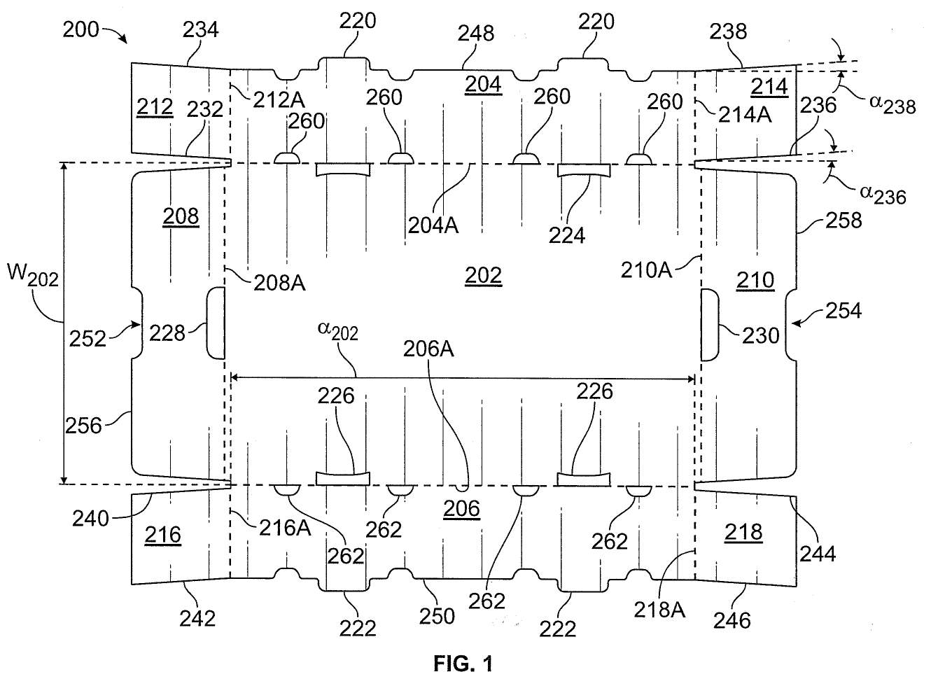

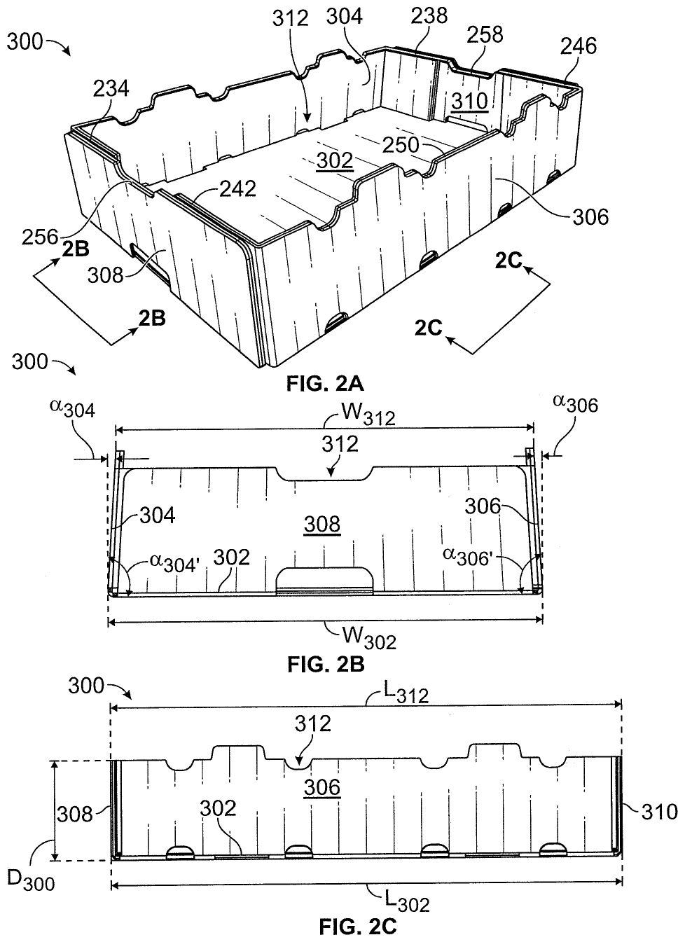

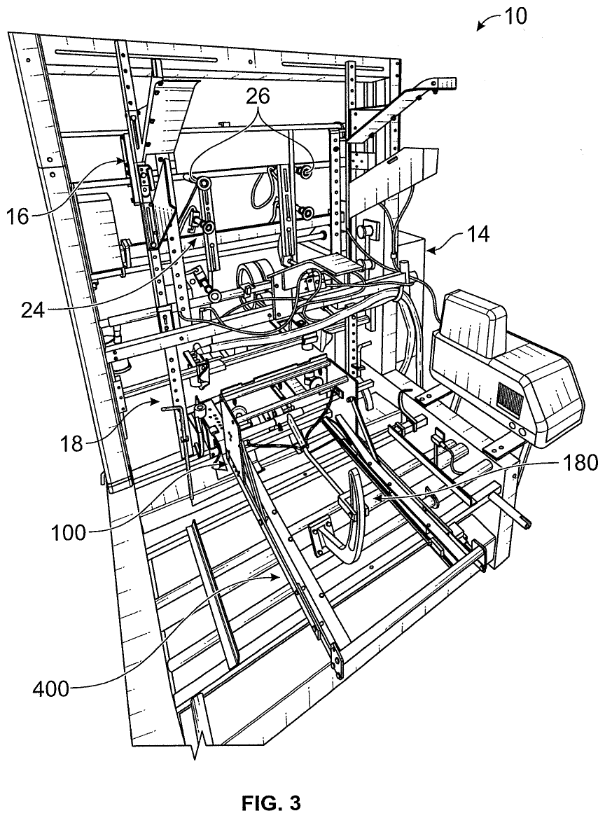

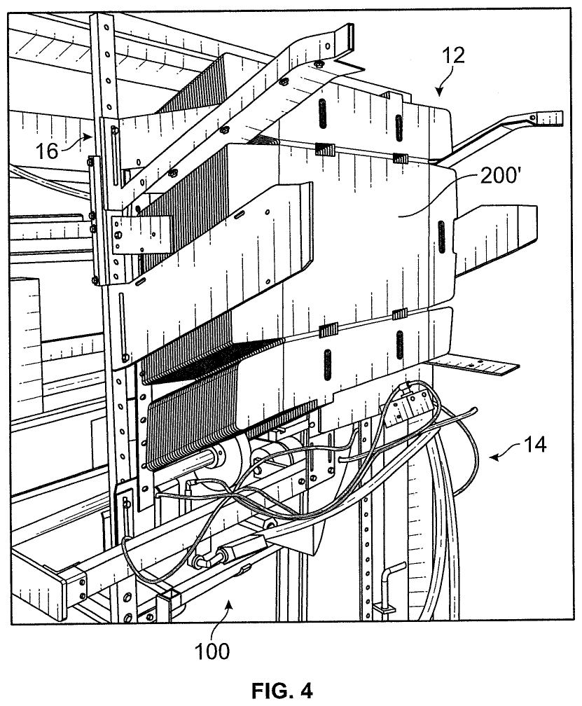

An example of an apparatus 10 in accordance with the present disclosure is shown generally in FIGS. 3 and 4. Components such as pneumatic lines, adhesive lines, hydraulic lines, electrical wiring, etc. have been omitted from, or are not labeled in, the drawings to depict aspects of the apparatus 10 in more detail. The apparatus 10 comprises stations that advance and fold blanks into a finished tray. The particular example of the apparatus 10 depicted herein may be directed to folding a particular sized and shaped blank to form a tapered tray. As described herein in more detail, the apparatus 10 may be used to fold a blank 200 (see FIG. 1) to form a tapered tray 300 (see FIGS. 2A-2C). In the example shown in FIG. 4, a different design of blank 200′ is depicted. It should be appreciated that the apparatus 10 may be used with various folding structures and drive assemblies to fold any number of different sized and shaped blanks to form corresponding trays.

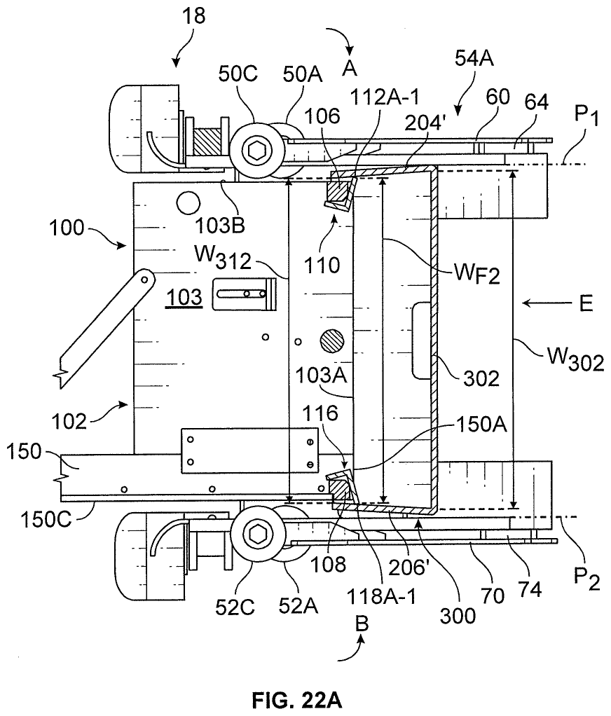

A feeding station 14 delivers and feeds blanks 200, 200′ into the folding structures associated with the apparatus 10. A stack 12 of blanks 200′ is shown in a hopper assembly 16 in FIG. 4, which may form a portion of the feeding station 14. Adjacent to the feeding station 14, i.e., below the feeding station 14 in the example shown in FIG. 3, is a folding station 18, which includes folding structures mounted therein for folding at least a portion of the blank 200, 200′. A mandrel assembly 100 advances the blank 200, 200′ into the folding station 18, as described herein, and the finished trays, e.g., tray 300 (see FIGS. 2A-2C), move onto receiving rails 90, from which the trays 300 may be manually removed for use, storage, or shipping, as shown in FIG. 22. The apparatus 10 may further comprise one or more controllers (not shown) that may use one or more sensors, e.g., optical sensors (not shown), to coordinate operation of the hopper assembly 16 and the mandrel assembly 100 to ensure proper feeding and folding of the blanks 200, 200′.

With reference to FIG. 1, one example of the blank 200 is illustrated. The blank 200 comprises a bottom panel 202, a first side panel 204, a second side panel 206, a third side panel 208, and a fourth side panel 210. The first side panel 204 is hingedly coupled to the bottom panel 202 along a fold line 204A; the second side panel 206 is hingedly coupled to the bottom panel 202 along a fold line 206A; the third side panel 208 is hingedly coupled to the bottom panel 202 along a fold line 208A; and the fourth side panel 210 is hingedly coupled to the bottom panel 202 along a fold line 210A. The first side panel 204 comprises two first minor or end flaps 212, 214 defined by respective fold lines 212A, 214A, and the second side panel 206 comprises two second minor or end flaps 216, 218 defined by respective fold lines 216A, 218A. The bottom panel 202 comprises a length L₂₀₂ and a width W₂₀₂.

The blank 200 may optionally comprise one or more stacking tabs formed on one or more of the first and second side panels 204, 206 and/or the third and fourth side panels 208, 210. In the example shown in FIG. 1, the first side panel 204 includes stacking tabs 220 extending outwardly from an outer edge 248 thereof, and the second side panel 206 includes stacking tabs 222 extending outwardly from an outer edge 250 thereof. Upon folding of the blank 200 into a tray 300 (see FIGS. 2A-2C), openings 224, 226 formed in the bottom panel 202 along the fold lines 204A, 206A may be configured to receive the stacking tabs of other trays 300 to allow the trays 300 to stack into each other as the trays 300 are formed and move onto the receiving rails 90 (see FIG. 22) and to be stacked on top of each other after removal from the receiving rails 90. Additional openings may optionally be formed in one or more of the side panels 204, 206 and/or 208, 210 to assist with picking up the tray 300. In the example shown in FIG. 1, the third and fourth side panels 208, 210 include respective openings 228, 230. Notches 252, 254 may extend inward from respective outer edges 256, 258 of the third and fourth side panels 208, 210 to assist with picking up another tray 300 stacked on top. One or more further openings, e.g., openings 260, 262, may optionally be formed in one or more of the side panels 204, 206 and/or 208, 210, which may serve as ventilation holes, e.g., for produce contained in the tray 300.

The first end flaps 212, 214 comprise substantially rectangular panels with a respective inner edge 232, 236 and outer edge 234, 238. The fold lines 212A, 214A along which the first end flaps 212, 214 are connected to the first side panel 204 are positioned laterally inward with respect to a respective one of the fold lines 208A, 210A along which the third and fourth side panels 208, 210 are connected to the bottom panel 202. The inner and outer edges 232, 236 and 234, 238 of the first end flaps 212, 214 extend outward at an angle relative to an adjacent edge of the bottom panel 202, as defined by the fold line 204A, thereby causing the first end flaps 212, 214 to extend outward at an angle with respect to the bottom panel 202 and the first, third, and fourth side panels 204, 208, 210. The second end flaps 216, 218 also comprise substantially rectangular panels with a respective inner edge 240, 244 and outer edge 242, 246, and the fold lines 216A, 218A along which the second end flaps 216, 218 are connected to the second side panel 206 are positioned laterally inward with respect to a respective one of the fold lines 208A, 210A along which the third and fourth side panels 208, 210 are connected to the bottom panel 202. The inner and outer edges 240, 244 and 242, 246 of the second end flaps 216, 218 similarly extend outward at an angle relative to an adjacent edge of the bottom panel 202, as defined by the fold line 206A, thereby causing the second end flaps 216, 218 to extend outward at an angle with respect to the bottom panel 202 and the second, third, and fourth side panels 206, 208, 210.

As illustrated with respect to one first end flap 214, the inner edge 236 extends outward, i.e., diverges, at an angle α₂₃₆ with respect to the fold line 204A, and the outer edge 238 extends outward, i.e., diverges, at an angle α₂₃₈ with respect to the outer edge 248 of the first side panel 204. Although not labeled, the respective inner edges 232, 240, 244 and outer edges 234, 242, 246 of the first and second end flaps 212, 216, 218 similarly extend outward, i.e., diverge, at an angle with respect to the fold lines 204A or 206A and the outer edges 248, 250 of the first or second side panel 204, 206. The angles of divergence α₂₃₆, α₂₃₈ of the inner and outer edges 232, 236, 240, 244 and 234, 238, 242, 246 of the first and second end flaps 212, 214 and 216, 218 may be substantially the same. The similarity of the angles of divergence α₂₃₆, α₂₃₈, along with the relative positioning of the fold lines 208A, 210A of the third and fourth side panels 208, 210 with respect to the fold lines 212A, 214A, 216A, 218A of the first and second end flaps 212, 214, 216, 218, allow the first and second side panels 204, 206 to taper inward when the tray 300 (see FIGS. 2A-2C) is formed, such that the outer edges 234, 238, 242, 246 of the first and second end flaps 212, 214 and 216, 218 create a flat corner with the outer edges 256, 258 of the third and fourth side panels 208, 210. In some examples, the angles of divergence α₂₃₆, α₂₃₈ may be from about 1 degree to about 5 degrees, and in some particular examples, the angles of divergence α₂₃₆, α₂₃₈ may be from about 3 degrees to about 5 degrees. The angles of divergence α₂₃₆, α₂₃₈ control a degree to which the first and second side panels 204, 206 taper inward in the finished tray 300, as described below.

With reference to FIGS. 2A-2C, the tray 300 is illustrated, which is adapted to be formed from the blank 200 of FIG. 1. FIG. 2B is a side view of the tray 300 taken along view lines 2B-2B in FIG. 2A, and FIG. 2C is a side view of the tray 300 taken along view lines 2C-2C in FIG. 2A. The tray 300 comprises a bottom 302, a first sidewall 304, a second sidewall 306, a third sidewall 308, and a fourth sidewall 310. With reference to the blank 200 shown in FIG. 1, as described herein in more detail, the tray 300 is formed by folding the first and second end flaps 212, 214 and 216, 218 inward (i.e., toward an inner surface of the respective first or second side panel 204, 206); folding the first and second side panels 204, 206 inward (i.e., toward an inner surface of the bottom panel 202); folding the third and fourth side panels 208, 210 inward (i.e., toward the inner surface of the bottom panel 202); and adhering an inner surface of the third or fourth side panels 208, 210 to an outer surface of an adjacent one of the first and second end flaps 212, 214 and 216, 218. Thus, the first side panel 204 defines the first sidewall 304; the second side panel 206 defines the second sidewall 306; the third side panel 208, the first end flap 212, and the second end flap 216 define the third sidewall 308; and the fourth side panel 210, the first end flap 214, and the second end flap 218 define the fourth sidewall 310. The outer edges 248, 250, 256, 258 of the first, second, third, and fourth side panels 204, 206, 208, 210, along with the outer edges 234, 238, 242, 246 of the first and second end flaps 212, 214, 216, 218, define upper edges of the tray 300 and define an opening 312 of the tray 300. As shown in FIGS. 2B and 2C, the bottom 302 of the tray 300 comprises a width W₃₀₂ that is defined by the width W₂₀₂ of the bottom panel 202 of the blank 200 (see FIG. 1) and a length L₃₀₂ that is defined by the length L₂₀₂ of the bottom panel 202 (see FIG. 1). The opening 312 of the tray 300 comprises a width W₃₁₂ and a length L₃₁₂, in which one of the width W₃₁₂ or the length L₃₁₂ of the opening 312 is less than the width W₃₀₂ or the length L₃₀₂ of the bottom 302 of the tray 300. The tray 300 also comprises a depth D₃₀₀.

In the example shown in FIGS. 2A-2C, the third and fourth sidewalls 308, 310 are substantially perpendicular to the bottom 302 of the tray 300, such that the length L₃₁₂ of the opening 312 is substantially the same as the length L₃₀₂ of the bottom 302 of the tray 300, but the width W₃₁₂ of the opening 312 is less than the width W₃₀₂ of the bottom 302 due to tapering of the first and second sidewalls 304, 306 with respect to the bottom 302. As described herein, when the tray 300 is formed from the blank 200, the end flaps 212, 214, 216, 218 are folded inward until the inner edges 232, 236, 240, 244 contact adjacent portions of the inner surface of the bottom panel 202 (e.g., just laterally inward of the fold lines 208A, 210A), which causes the first and second side panels 204, 206 to taper inward in the finished tray 300. The first sidewall 304 extends inward (i.e., toward the second sidewall 306) at an (outer) angle α₃₀₄ with respect to a line extending perpendicular to the bottom 302 of the tray 300, and the second sidewall 306 similarly extends inward (i.e., toward the first sidewall 304) at an (outer) angle α₃₀₆ with respect to a line extending perpendicular to the bottom 302, in which the angle α₃₀₄ may be substantially the same as the angle α₃₀₆. The angles α₃₀₄, α₃₀₆ correspond to, and are defined by, the angles of divergence, e.g., angles α₂₃₆, α₂₃₈ (see FIG. 1), of the first and second end flaps 212, 214, 216, 218. In some examples, the angles α₃₀₄, α₃₀₆ may be from about 1 degree to about 5 degrees, and in other examples, the angles α₃₀₄, α₃₀₆ may be from about 3 degrees to about 5 degrees. Viewed another way, the first sidewall 304 may extend inward at an inner angle α_{304′} with respect to the bottom 302 of the tray 300, and the second sidewall 306 may similarly extend inward at an inner angle α_{306′} with respect to the bottom 302. The inner angles α_{304′}, α_{306′} may be substantially the same as each other and are both less than 90 degrees. For example, the inner angles α_{304′}, α_{306′} may be between about 85 degrees to about 89 degrees with respect to the bottom 302, and in some particular examples, the inner angles α_{304′}, α_{306′} may be between about 85 degrees to about 87 degrees with respect to the bottom 302.

It may be understood that in other examples (not shown) the third and fourth sidewalls 308, 310 may taper inward, such that the length L₃₁₂ of the opening 312 is less than the length L₃₀₂ of the bottom 302 of the tray 300 and the width W₃₁₂ of the opening 312 is substantially the same as the width W₃₀₂ of the bottom 302. It may also be understood that although the tray 300 shown in FIGS. 2A-2C is substantially rectangular, the blank 200 may be dimensioned to create a tray with any desired dimensions, including a square tray having a same length and width.

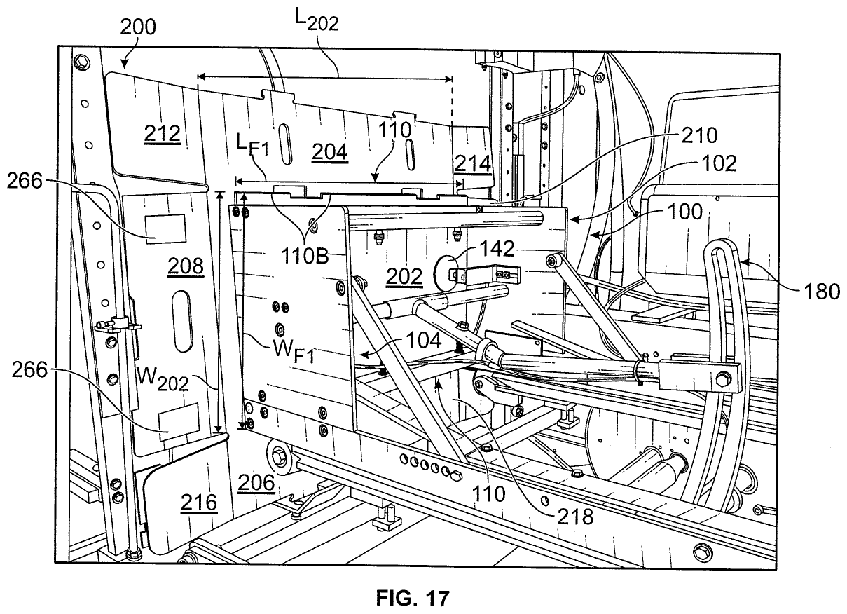

Referring to FIGS. 1, 3, and 4, the blanks 200, 200′ may be placed into the hopper assembly 16, which is designed to hold the stack 12 of blanks 200, 200′ for placement in a feed position in front of the mandrel assembly 100, which advances the blank 200, 200′ into the folding station 18. The hopper assembly 16 comprises a vacuum assembly 24, which includes one or more vacuum cups 26 designed to contact one or more portions of one of the blanks 200, 200′ to draw the blank 200, 200′ out of the stack 12 and move the blank 200, 200′ in a downward fashion into the feed position. The feed position is best shown in FIG. 17, in which one of the blanks 200 has been positioned in front of the mandrel assembly 100 ready to be advanced into the folding station 18. The exemplary vacuum assembly 24 utilizes six vacuum cups 26 placed in spaced-apart positions relative to the blanks 200, 200′ to allow the vacuum cups 26 to contact and engage one or more portions of the blank 200, 200′ once a vacuum source (not shown) is actuated causing a vacuum to be applied at the vacuum cups 26. The vacuum assembly 24 is designed to move up and down to engage the blanks 200, 200′ and move them into the feed position via an actuating motor (not shown) that is attached to the vacuum assembly 24 and moves the entire unit in an up and down motion. While one example of a feeding station 14 is depicted, it should be appreciated that other ways of feeding the blanks 200, 200′ may be implemented.

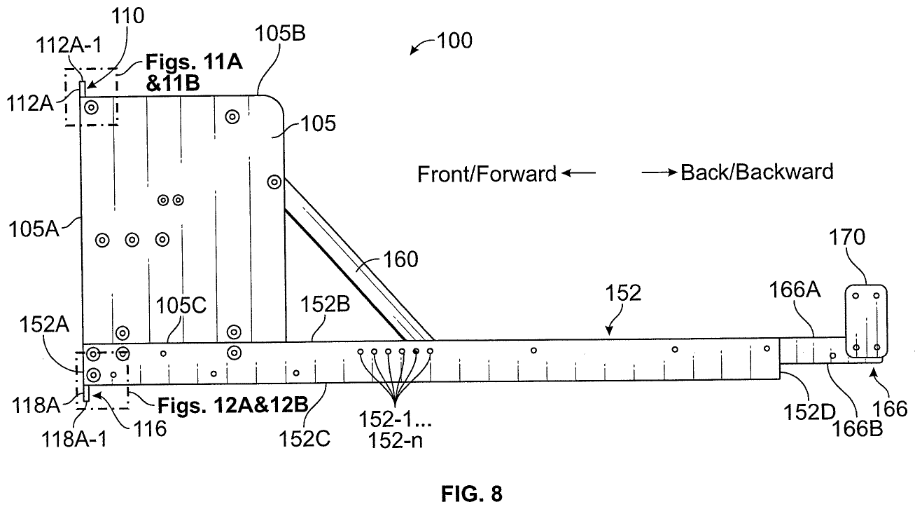

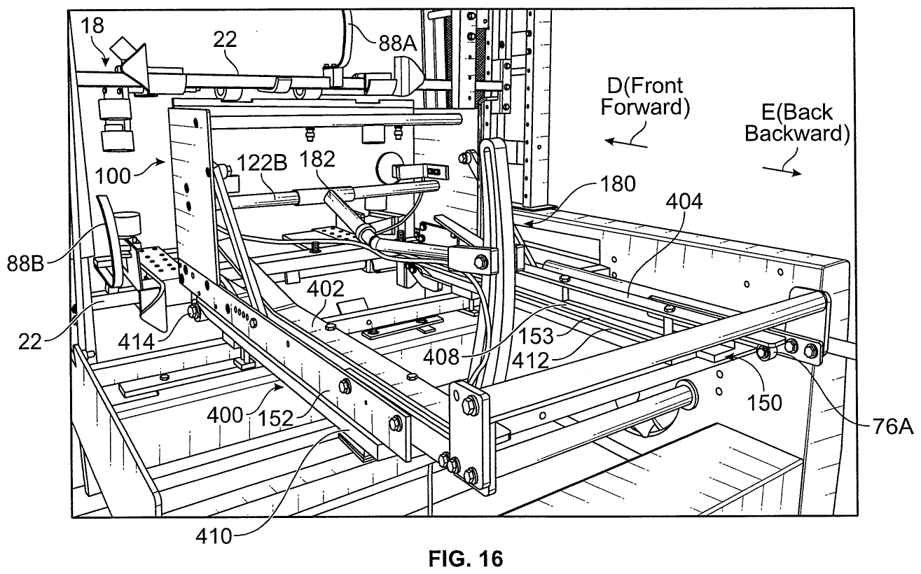

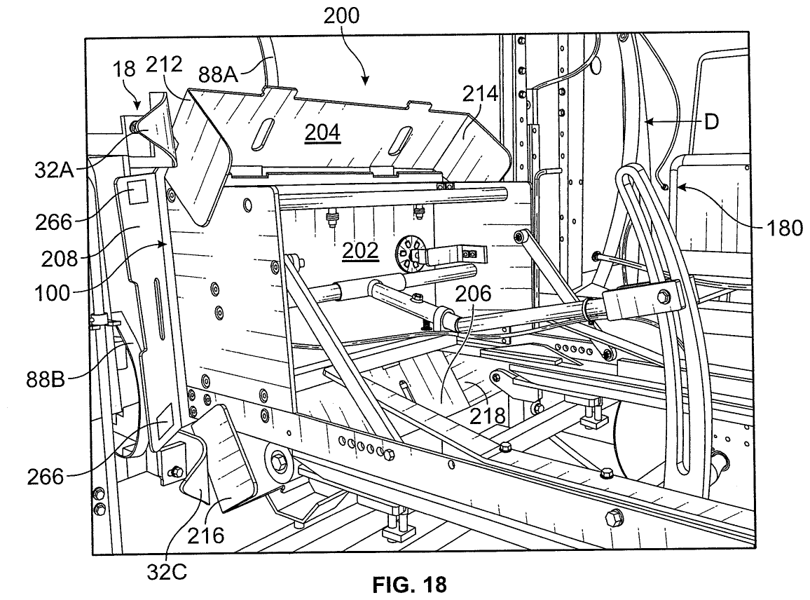

With reference to FIGS. 17-22, as described herein in more detail, once one of the blanks 200 has been moved to the feeding position, the mandrel assembly 100 advances toward the folding station 18 to a first position, where the mandrel assembly 100 engages the bottom panel 202 of the blank 200 and begins to move the blank 200 toward and into the folding station 18 (see FIG. 17). The mandrel assembly 100 continues advancing to one or more additional positions within the folding station 18 to form the finished tray 300 and then withdraws from the finished tray 300 to allow the hopper assembly 16 to place another blank 200 in the feed position (see FIGS. 18-22). Terms such as “front/forward” and “back/backward” and derivatives thereof are used herein to reference movement of the mandrel assembly 100 with respect to components of the folding station 18, with “front/forward” referring to advancement of the mandrel assembly 100 toward the folding station 18 and “back/backward” referring to withdrawal of the mandrel assembly 100 away from the folding station 18 (see FIGS. 8 and 16).

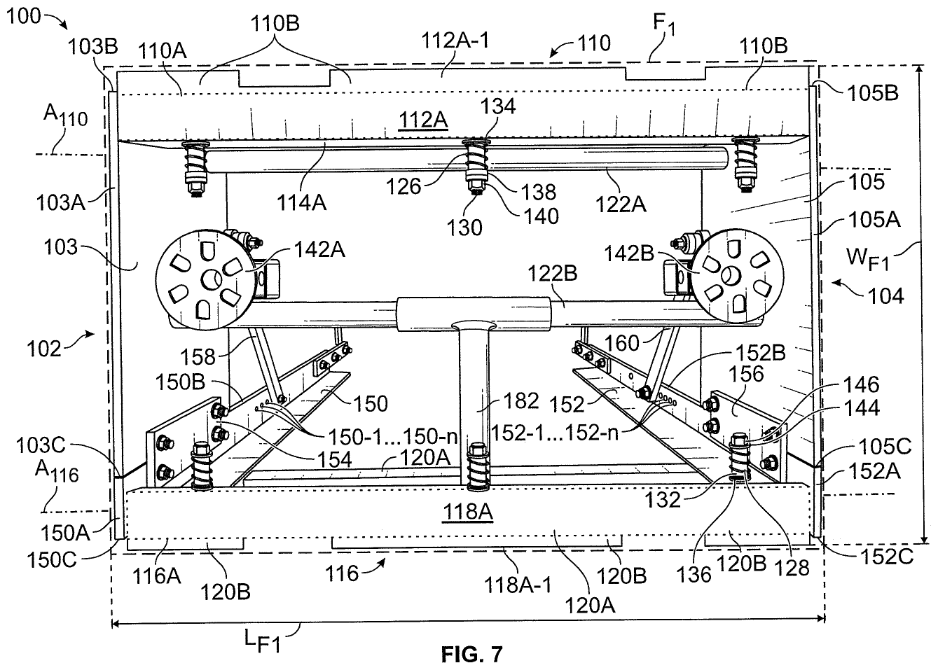

With reference to the example shown in FIGS. 7-10, the mandrel assembly 100 may comprise a first side plate 102; a second side plate 104 spaced apart from the first side plate 102; a first bar 106 and a second bar 108 that are each coupled to, and extend between, the first and second side plates 102, 104, with the second bar 108 being spaced apart from the first bar 106; a first forming element 110 pivotally coupled to the first bar 106; and a second forming element 116 pivotally coupled to the second bar 108. The mandrel assembly 100 may comprise one or more additional bars 122A, 122B extending between the first and second side plates 102, 104, which may serve to strengthen the mandrel assembly 100 and prevent movement of the first and second side plates 102, 104 relative to each other. As described herein in more detail, one or more of the additional bars, e.g., additional bar 122B, may also be used to couple the mandrel assembly 100 to an actuator 180 (see FIGS. 3 and 16).

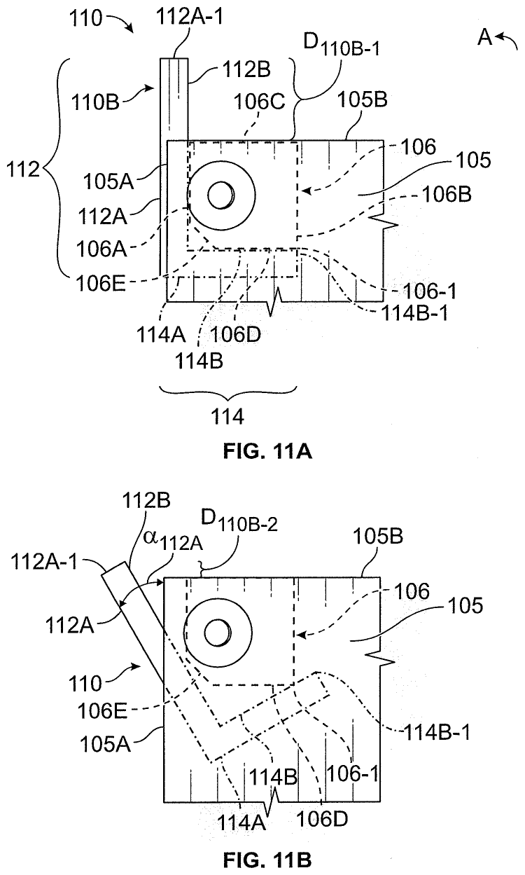

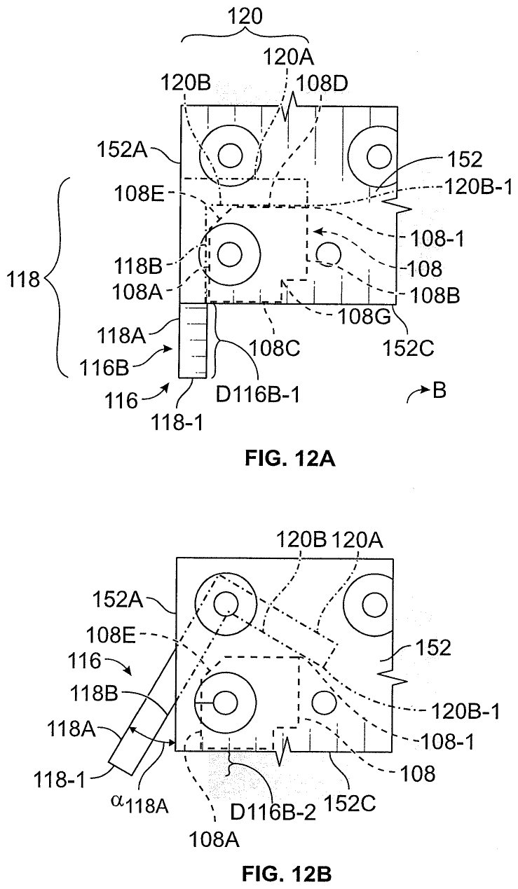

In the example shown, the first side plate 102 may comprise an assembly including a first main plate 103 and a first rail 150, and the second side plate 104 may similarly comprise an assembly including a second main plate 105 and a second rail 152. With reference to FIGS. 7 and 8, the first and second main plates 103, 105 may comprise a respective front edge 103A, 105A, upper edge 103B, 105B, and lower edge 103C, 105C; and the first and second rails 150, 152 may comprise a front edge 150A, 152A, an upper edge 150B, 152B, and a lower edge 150C, 152C (see also FIGS. 11A, 11B, 12A, and 12B). The first and second main plates 103, 105 are coupled to a respective one of the first and second rails 150, 152, e.g. via brackets 154, 156, at a junction between lower edges 103C, 105C of the first and second main plates 103, 105 and upper edges 150B, 152B of the first and second rails 150, 152, such that the upper edges 103B, 105B of the first and second main plates 103, 105 define upper edges of the first and second side plates 102, 104; the front edges 103A, 105A of the first and second main plates 103, 105 and the front edges 150A, 152A of the first and second rails 150, 152 collectively define front edges of the first and second side plates 102, 104; and the lower edges 150C, 152C of the first and second rails 150, 152 define lower edges of the first and second side plates 102, 104. The front edges 103A, 105A of the first and second main plates 103, 105 are parallel to, and flush with, the respective front edges 150A, 152A of the first and second rails 150, 152. In other examples (not shown) of the first and second side plates 102, 104, the first and second main plates 103, 105 may be integral with the first and second rails 150, 152 (i.e., a single piece of material) or may be coupled to the first and second rails 150, 152, such that the front edges 103A, 105A of the first and second main plates 103, 105 define the front edges of the first and second side plates 102, 104; and the lower edges 103C, 105C of the first and second main plates 103, 105 define the lower edges of the first and second side plates 102, 104.

As shown in FIGS. 7, 8, and 9A, support brackets 158, 160 may extend at an angle between respective ones of the first and second main plates 103, 105 and the first and second rails 150, 152. The rails 150, 152 may comprise a plurality of apertures 150-1 . . . 150-n and 152-1 . . . 152-n, e.g., to accommodate first and second main plates 103, 105 of differing dimensions and/or additional components. Brackets 162A, 162B may be coupled to a respective one of the first main plate 103 or the second main plate 105 to support vacuum cups 142, which engage the blank 200 (see FIGS. 1 and 17) as described herein.

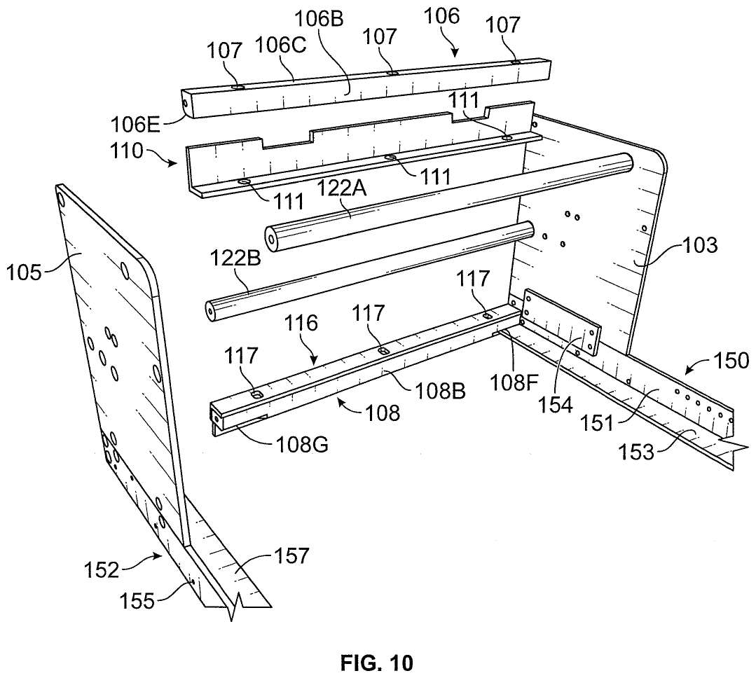

As best seen in FIGS. 10, 11A, and 12A, the first forming element 110 comprises an “L” shape having a first portion 112 and a second portion 114, in which the second portion 114 is substantially perpendicular to the first portion 112. The first portion 112 includes a first front surface 112A with a first substantially planar outer edge 112A-1, and a first back surface 112B. The second portion 114 includes a first inner surface 114A and a first outer surface 114B. The second forming element 116 may comprise a similar “L” shape, with a first portion 118 and a second portion 120 that is substantially perpendicular to the first portion 118. The first portion 118 includes a second front surface 118A with a second substantially planar outer edge 118A-1, and a second back surface 118B. The second portion 120 includes a second inner surface 120A and a second outer surface 120B. Terms such as “inner,” “outer,” “up/upper/upward,” “down/downward/lower,” and derivatives thereof, when used with respect to components of the mandrel assembly 100, refer to the component's orientation when assembled on the mandrel assembly 100.

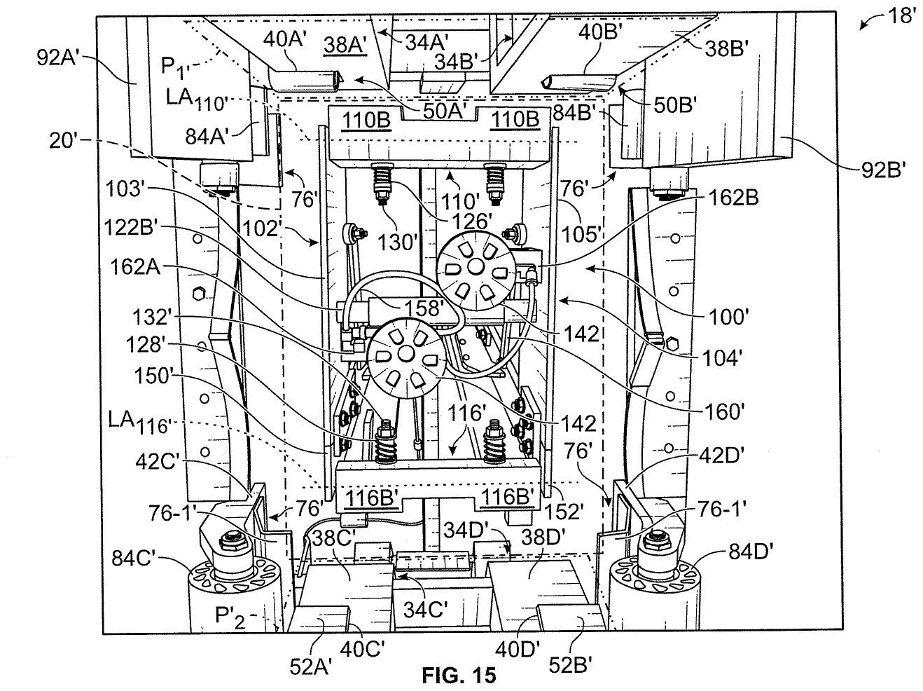

As shown in FIG. 7, the first forming element 110 comprises a first main body 110A (indicated with short dashed lines) and at least one first forming section 110B that extends beyond the first main body 110A. The at least one forming section 110B may be integral with the first main body 110A and includes the first substantially planar outer edge 112A-1. The first main body 110A and the at least one first forming section 110B may define the first portion 112 (see FIG. 11A) of the first forming element 110. The second forming element 116 similarly comprises a second main body 116A (indicated with short dashed lines) and at least one second forming section 116B that extends beyond the second main body 116A. The at least one second forming section 116B may be integral with the second main body 116A and includes the second substantially planar outer edge 118A-1. The second main body 116A and the at least one second forming section 116B may define the first portion 118 (see FIG. 12A) of the second forming element 116. In the example shown in FIG. 7, the first forming element 110 comprises three first forming sections 110B and the second forming element 116 comprises three second forming sections 116B. It may be understood that the forming elements may comprise one forming section, two forming sections (see FIG. 15), four forming sections, etc.

The first and second bars 106, 108 are fixed to the first and second side plates 102, 104, such that the first and second bars 106, 108 do not move relative to the first and second side plates 102, 104. In the example shown, the first bar 106 is fixed to the first and second main plates 103, 105, e.g., via fasteners (not labeled), and the second bar 108 is fixed to the first and second rails 150, 152, e.g., via fasteners (not labeled). As best seen in FIGS. 10 and 11A, the first bar 106 comprises a front surface 106A, a back surface 106B, an outer surface 106C, and an inner surface 106D, with a chamfered edge 106E being formed between the front and inner surfaces 106A, 106D. As best seen in FIGS. 10 and 12A, the second bar 108 similarly comprises a front surface 108A, a back surface 108B, an outer surface 108C, and an inner surface 108D, with a chamfered edge 108E being formed between the front and inner surfaces 108A, 108D. In other examples (not shown), the forming elements 110, 116 may be integral with the bars 106, 108.

As shown in FIGS. 10 and 12A, the second bar 108 may further comprise notches 108F, 108G that are configured to receive the respective first and second rails 150, 152. For example, as shown with respect to the first rail 150 in FIG. 10, the first rail 150 may comprise an “L” shape having a first portion 151 and a second portion 153, in which the second portion 153 extends perpendicular to the first portion 151. The bracket 154 couples the first main plate 103 to the first portion 151 of the first rail 150. The second portion 153 of the first rail 150 is received in the notch 108F formed in the second forming element 116 and is secured to the second forming element 108 via fasteners (not visible). The second rail 152 similarly comprises an “L” shape with a first portion 155 and a second portion 157 that is perpendicular to the first portion 155, and although not visible, the second portion 157 is received in the notch 108G (see also FIG. 12A) and is secured to the second forming element 108 via fasteners (not visible).

As shown in FIGS. 7, 8, and 10 and discussed in more detail below, the first and second forming elements 110, 116 may be coupled to a respective one of the first bar 106 or the second bar 108 via one or more fasteners, such as a partially threaded bolt 130, 132. The bolts 130, 132 are received in, and extend through, a respective opening formed in the first or second bar 106, 108 (only the openings 107 formed in the first bar 106 are visible in FIG. 10) and a respective opening 111, 117 formed in the first or second forming element 110, 116 and are secured in place via a corresponding nut 140, 146 secured to a threaded end portion (not separately labeled) of the bolt 130, 132. To allow for pivoting movement of the first and second forming elements 110, 116 relative to the first and second bars 106, 108 and the bolts 130, 132, the openings 111, 117 formed in the first and second forming elements 110, 116 may be oversized relative to a diameter of the bolts 130, 132.

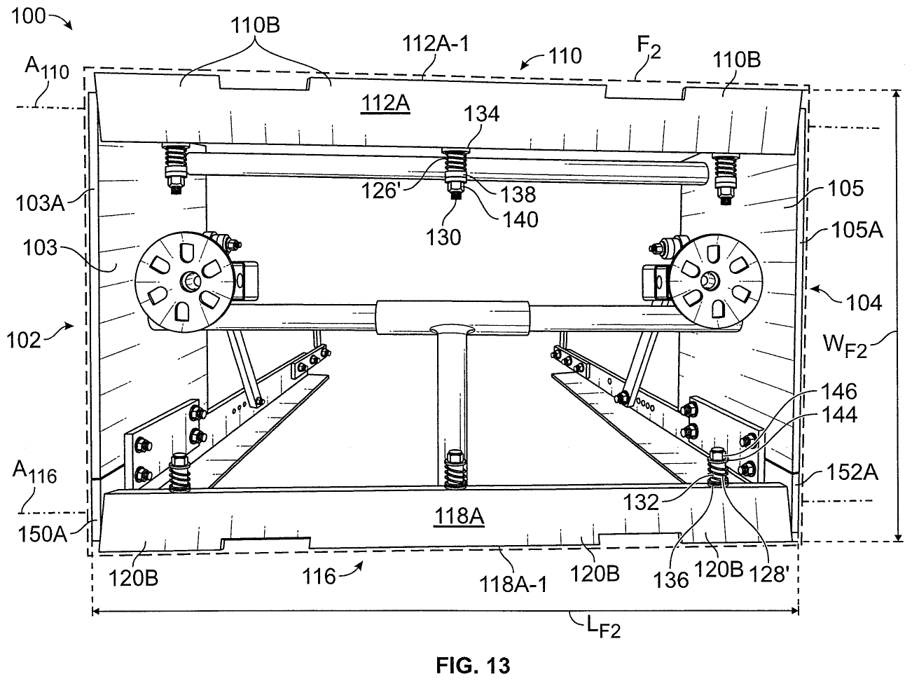

The first forming element 110 is configured to rotate with respect to the first bar 106 from a home position to a collapsed position, and the second forming element 116 is similarly configured to rotate with respect to the second bar 108 from a home position to a collapsed position. In particular, with reference to FIGS. 11A and 11B, the first forming element 110 is configured to rotate with respect to the first bar 106 in a first direction (indicated by arrow A) by a first amount from the home position, as shown in FIG. 11A (see also FIGS. 7 and 8), to the collapsed position, as shown in FIG. 11B (see also FIG. 13). With reference to FIGS. 12A and 12B, the second forming element 116 is configured to rotate with respect to the second bar 108 in a second direction (indicated by arrow B) by a second amount from the home position, as shown in FIG. 12A (see also FIGS. 7 and 8), to the collapsed position, as shown in FIG. 12B (see also FIG. 13), in which the second direction B is opposite the first direction A. In some examples, the second amount may be substantially equal to the first amount. In other examples, the first and second amounts may be different.

In some examples, the structure of the first and second forming elements 110, 116 may be substantially similar, with the first and second portions 112, 114 of the first forming element 110 comprising dimensions similar to the first and second portions 118, 120 of the second forming element 116. With reference to the examples shown in FIGS. 11A, 11B, 12A, and 12B, a height of the first portions 112, 118 (as measured between the first and second substantially planar outer edges 112A-1, 118A-1 and the first and second inner surfaces 114A, 120A, respectively) may be substantially the same, e.g., about 2.0 inches, and a depth of the first and second inner surfaces 114A, 120A (as measured in a front to back direction) may be substantially the same, e.g., about 1.0 inch. In other examples, the dimensions of the first and second portions 112, 114 of the first forming element 110 may be different from the dimensions of the first and/or second portions 118, 120 of the second forming element 116. With reference to the example shown in FIGS. 7 and 13, the height (e.g., about 2.0 inches) of the first portion 112 (not labeled; see FIG. 11A) of the first forming element 110 may be greater than the height (e.g., about 1.5 inches) of the first portion 118 (not labeled; see FIG. 12A) of the second forming element 116.

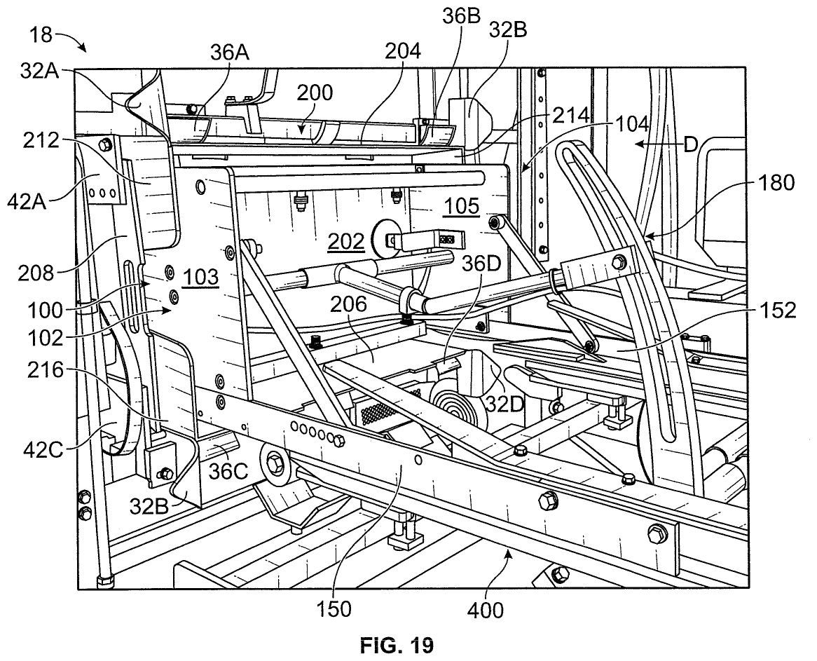

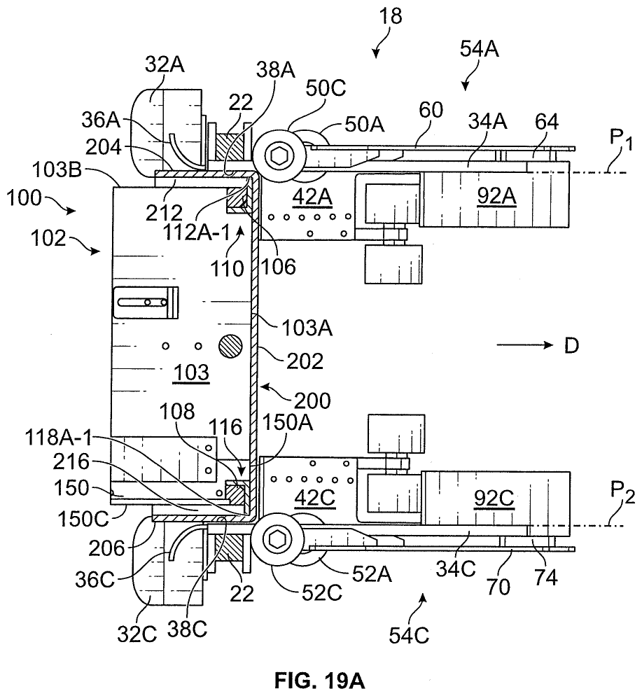

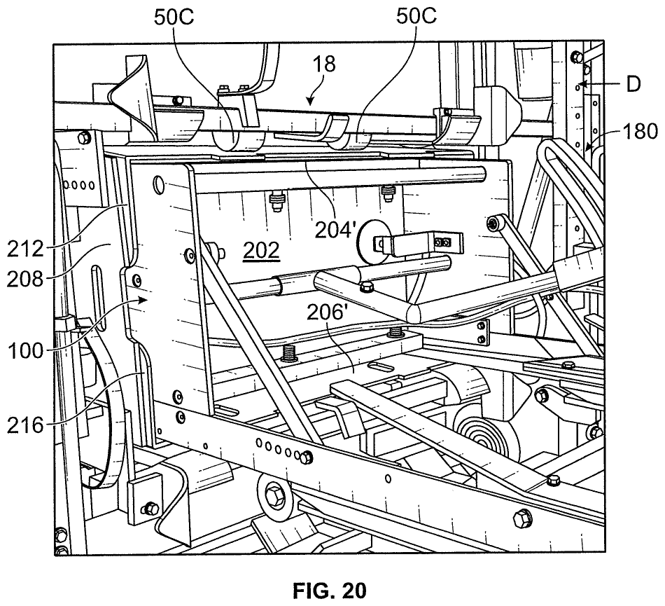

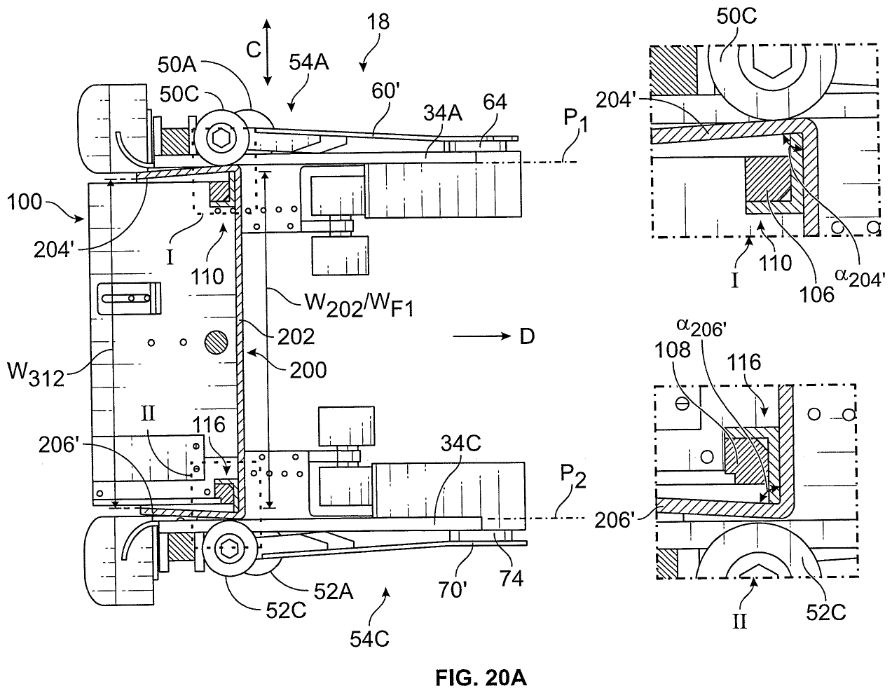

As shown in FIGS. 7, 8, 11A, and 12A, when the first and second forming elements 110, 116 are in the home position, the respective first and second front surfaces 112A, 118A of the first and second forming elements 110, 116 are substantially parallel to, or aligned with, the front edges of the first and second side plates 102, 104, i.e., with the front edges 103A, 105A of the first and second main plates 103, 105 and the front edges 150A, 152A of the first and second rails 150, 152; the first and second substantially planar outer edges 112A-1, 118A-1 and the first and second inner and outer surfaces 114A, 120A and 114B, 120B of the second portions 114, 120 of the first and second forming elements 110, 116 are substantially parallel with each other; the first forming element 110, specifically the first forming section(s) 110B of the first forming element 110, extends beyond the upper edges of the first and second side plates 102, 104 (i.e., above the first and second upper edges 103B, 105B of the first and second main plates 103, 105) by a first distance D_{110B-1}; and the second forming element 116, specifically the second forming section(s) 116B of the second forming element 116, extends beyond the lower edges of the first and second side plates 102, 104 (i.e., below the lower edges 150C, 152C of the first and second rails 150, 152) by a first distance D_{116B-1} (see also FIGS. 19A and 20A).

As shown in FIG. 7, the first and second forming sections 110B, 116B (specifically the first and second substantially planar outer edges 112A-1, 118A-1), along with the front edges of the first and second side plates 102, 104 (specifically the front edges 103A, 105A of the first and second main plates 103, 105 and the front edges 150A, 152A of the first and second rails 150, 152), collectively define a first footprint F₁ (indicated with long dashed lines) having a first width W_{F1} and a first length L_{F1}. The first and second bars 106, 108, the first and second forming elements 110, 116, and the additional bar(s) 122A, 122B may all comprise a same length (not labeled), and the first length L_{F1} of the first footprint F₁ may be adjusted by, for example, adding or removing one or more spacers that may be positioned between these components and the first and/or second main plates 103, 105. As described herein, the height (not labeled) of the first sections 112, 118 (see FIGS. 11A and 12A) of the first and second forming elements 110, 116 may be the same or different, and the first width W_{F1} of the first footprint F₁ may be adjusted by, for example, adding or removing one or more spacers that may be positioned between the first outer surface 114B of the first forming element 110 and the first bar 106 and/or between the second outer surface 120B of the second forming element 116 and the second bar 108.

With reference to FIGS. 7, 11A, 11B, 12A, 12B, and 13, to move the first and second forming elements 110, 116 from the home position to the collapsed position, the first forming element 110 rotates in the direction A by the first amount about an axis A₁₁₀, and the second forming element 116 rotates in the direction B by the second amount about an axis A₁₁₆ that is parallel to the axis A₁₁₀. In the collapsed position, the first front surface 112A of the first forming element 110 may be positioned at an angle α_{112A} (also referred to herein as a first angle) with respect to the front edge of the first and second side plates 102, 104 (i.e., with respect to the front edges 103A, 105A of the first and second main plates 103, 105); the second front surface 118A of the second forming element 110 may be positioned at an angle α_{118A} (also referred to herein as a second angle) with respect to the front edge of the first and second side plates 102, 104 (i.e., with respect to the front edges 150A, 152A of the first and second rails 150, 152); the first substantially planar outer edge 112A-1 and the first inner and outer surfaces 114A and 114B of the first forming element 110 are positioned at an angle with respect to respective ones of the second substantially planar outer edge 118A-1 and the second inner and outer surfaces 120A, 120B of the second forming element 116; the first forming element 110, specifically the first forming section(s) 110B of the first forming element 110, extends beyond the upper edges of the first and second side plates 102, 104 (i.e., above the first and second upper edges 103B, 105B of the first and second main plates 103, 105) by a second distance D_{110B-2}; and the second forming element 116, specifically the second forming section(s) 116B of the second forming element 116, extends beyond the lower edges of the first and second side plates 102, 104 (i.e., below the lower edges 150C, 152C of the first and second rails 150, 152) by a second distance D_{116B-2} (see also FIG. 22A). The second distance D_{110B-2} is less than the first distance D_{110B-1}, and the second distance D_{116B-2} is less than the first distance D_{116B-1}.

As shown in FIG. 13, when the first and second forming elements 110, 116 are in the collapsed position, the first and second forming sections 110B, 116B (specifically the first and second substantially planar outer edges 112A-1, 118A-1 of the first and second forming sections 110B, 116B) and the front edges of the first and second side plates 102, 104 (specifically the front edges 103A, 105A of the first and second main plates 103, 105 and the front edges 150A, 152A of the first and second rails 150, 152) collectively define a second footprint F₂ (indicated with long dashed lines) having a second width W_{F2} and a second length L_{F2}. The second width W_{F2} of the second footprint F₂ is smaller than the first width W_{F1} of the first footprint F₁ due to the rotation of the first and second forming elements 110, 116 in the respective first and second directions A, B. When the first and second forming elements 110, 116 are in the collapsed position, the angles α_{112A}, α_{118A} of the first and second front surfaces 112A, 118A of the first and second forming elements 110, 116 may be substantially equal, e.g., when the height of the first portions 112, 118 of the first and second forming elements 110, 116 are the same, as shown in FIGS. 11B and 12B and described herein. In other examples, the angles α_{112A}, α_{118A} may be different. For example, when the height of the first portion 112 of the first forming element 110 is greater than the height of the first portion 118 of the second forming element 116, as described herein (see FIG. 7), the angle α_{112A} may be greater than the angle α_{118A} to achieve the desired second width W_{F2} of the second footprint F₂ shown in FIG. 13. In some examples, the angles α_{112A}, α_{118A} may be from about 1 degree to about 5 degrees, and in other examples, angles α_{112A}, α_{118A} may be from about 3 degrees to about 5 degrees.

As shown in FIG. 7, the mandrel assembly 100 may comprise at least one first biasing element configured to bias the first forming element 110 toward the home position, and at least one second biasing element configured to bias the second forming element 116 toward the home position. As discussed above, the first and second forming elements 110, 116 may be coupled to a respective one of the first bar 106 or the second bar 108 via one or more fasteners such as the partially threaded bolts 130, 132 and corresponding nuts 140, 146. In the example shown in FIG. 7, a washer 134 is fitted over the bolt 130 and rests against the first inner surface 114A of the first forming element 110. The first biasing element comprises a compression spring 126 that is positioned between the first inner surface 114A of the first forming element 110, specifically the washer 134, and a further washer 138, such that a first securing element is provided, which may comprise the nut 140 secured on the bolt 130. The compression spring 126 is fitted over the bolt 130 and positioned between the washers 134 and 138 located above and below the spring 126. The nut 140 engages a surface (not labeled) of the washer 138 opposite a surface (not labeled) of the washer 138 that engages the spring 126. The second biasing element may similarly comprise a compression spring 128 that is fitted over the bolt 132 and is positioned between the second inner surface 120A of the second forming element 116, specifically a washer 136 that rests against the second inner surface 120A, and a further washer 144, such that a second securing element is provided, which may comprise the nut 146 secured on the bolt 132.

When the first forming element 110 is in the home position as shown in FIGS. 7 and 11A, an outer corner 114B-1 of the first outer surface 114B is adjacent to an outer corner 106-1 (formed by a junction of the back surface 106B and inner surface 106D) of the first bar 106. When the first forming element 110 moves from the home position to the collapsed position due to engagement with a portion of the finished tray 300 as discussed further below, the first portion 112 of the first forming element 110 moves, i.e., downward, away from the first bar 106, as shown in FIGS. 11B and 13, and pivots or rotates about the axis A₁₁₀, such that the outer corner 114B-1 of the first outer surface 114B moves away from, i.e., upward from, the outer corner 106-1 of the first bar 106. In the example shown in FIGS. 7 and 13, when the first forming element 110 moves to the collapsed position, the first forming element 110 is able to move relative to its corresponding bolt 130 because the opening 111 in the first forming element 110 is oversized relative to a diameter of the bolt 130. Further, the first biasing element, i.e., the compression spring 126, is compressed between the washers 134 and 138 and moves to a compressed position, as indicated by reference numeral 127 in FIG. 13. When the first forming element 110 is no longer engaged with the tray 300, the compression spring 127 exerts a force against the washers 124 and 138 to bias the first forming element 110 back to the home position, such that the compression spring 127 returns to its uncompressed or partially compressed position (126), as shown in FIG. 7. As shown in FIGS. 11A and 11B, the chamfered edge 106E of the first bar 106 allows for rotation of the first forming element 110 between the home and collapsed position. The first forming element 110 is prevented from rotating from the home position in a direction opposite the direction A primarily by contact between the back surface 112B of the first forming element 110 and the front surface 106A of the first bar 106 due to the lack of a chamfered edge between the front and outer surfaces 106A, 106C of the first bar 106.

When the second forming element 116 is in the home position as shown in FIGS. 7 and 12A, an outer corner 120B-1 of the second outer surface 120B is adjacent to an outer corner 108-1 (formed by a junction of the back surface 108B and inner surface 108D) of the second bar 108. When the second forming element 116 moves from the home position to the collapsed position due to engagement with a portion of the finished tray 300 as discussed further below, the first portion 118 of the second forming element 116 moves, i.e., upward, away from the second bar 108 and pivots or rotates about the axis A₁₁₆, such that the outer corner 120B-1 of the second outer surface 120B moves away from, i.e., downward from, the outer corner 108-1 of the second bar 108. In the example shown in FIGS. 7 and 13, when the second forming element 116 moves to the collapsed position, the second forming element 116 is able to move relative to its corresponding bolt 132 because the opening 117 in the second forming element 116 is oversized relative to a diameter of the bolt 132. Further, the second biasing element, i.e., the compression spring 128, is likewise compressed between the washers 136 and 144 and moves to a compressed position, as indicated by reference numeral 129 in FIG. 13. When the second forming element 116 is no longer engaged with the tray 300, the compression spring 129 exerts a force against the washers 136 and 144 to bias the second forming element 116 back to the home position such that the compression spring 129 returns to its uncompressed or partially compressed position (128), as shown in FIG. 7. As shown in FIGS. 12A and 12B, the chamfered edge 108E of the second bar 108 similarly assists with rotation of the second forming element 116 between the home and collapsed position, and the second forming element 116 is prevented from rotating from the home position in a direction opposite the direction B primarily by contact between the back surface 118B of the second forming element 116 and the front surface 108A of the second bar 108 due to the lack of a chamfered edge between the front and outer surfaces 108A, 108C of the second bar 108. In other examples, the washers 134, 136, 138, 144 may be eliminated, such that the compression spring 126 may be compressed between the first forming element 110 and the nut 140 and the compression spring 128 may similarly be compressed between the second forming element 116 and the nut 146.

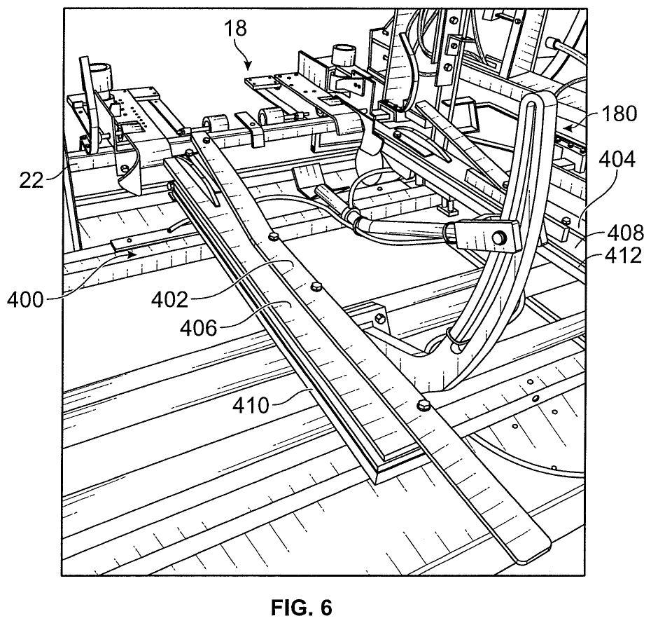

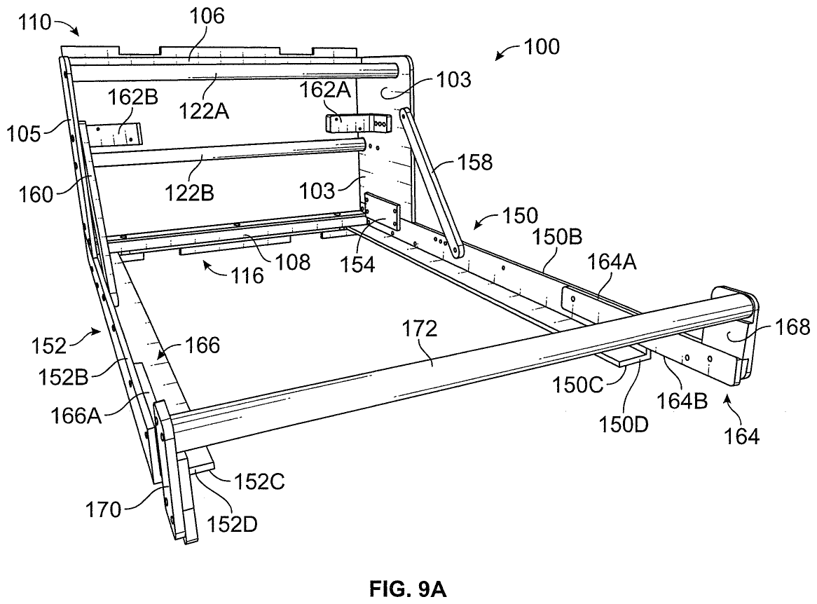

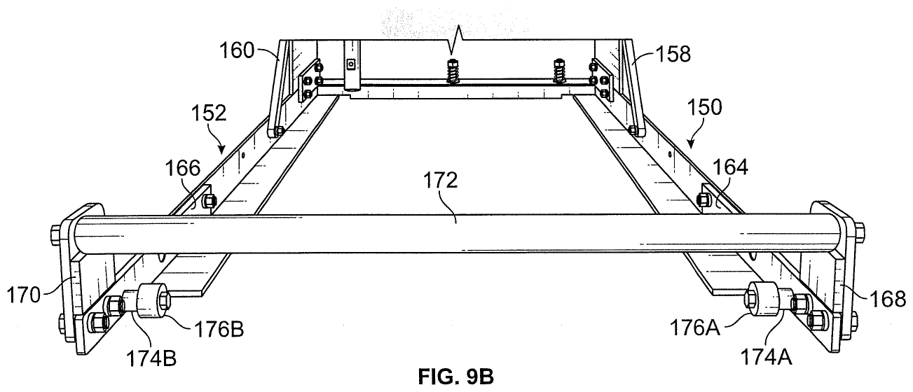

With reference to FIGS. 8, 9A, and 9B, the mandrel assembly 100 may comprise a support assembly comprising a first support bar 164 coupled to the first rail 150; a second support bar 166 coupled to the second rail 152; a first support plate 168 coupled to the first support bar 164; a second support plate 170 coupled to the second support bar 166; and a cross beam 172 extending between and coupled to the support plates 168, 170. Each support bar 164, 166 may comprise a respective extension 174A, 174B configured to receive a roller 176A, 176B, as shown in FIG. 9B (see also FIG. 16). As shown in FIGS. 8 and 9A, the first support bar 164 is coupled to an inner surface of the first rail 150, such that an upper edge 164A of the first support bar 164 is flush with the upper edge 150B of the first rail 150; a lower edge 164B of the first support bar 164 is raised above the lower edge 150C of the first rail 150; and the first support bar 164 extends past a rear edge 150D of the first rail 150. The second support bar 166 is similarly coupled to an inner surface of the second rail 152, such that an upper edge 166A of the second support bar 166 is flush with the upper edge 152B of the second rail 152; a lower edge 166B of the second support bar 166 is raised above the lower edge 152C of the second rail 152; and the second support bar 166 extends past a rear edge 152D of the second rail 152. As discussed below with respect to FIGS. 6 and 16, the support assembly helps to align the mandrel assembly 100 with respect to the folding station 18 and supports the mandrel assembly 100 as it advances toward, and withdraws from, the folding station 18.

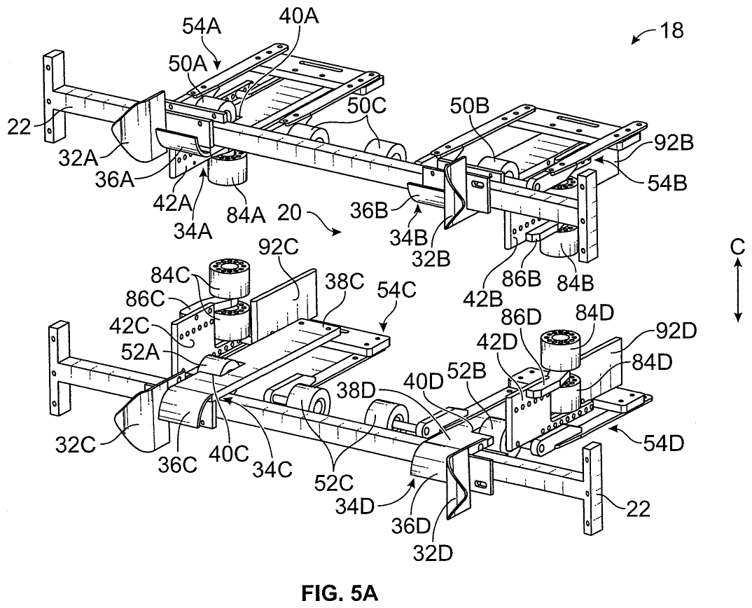

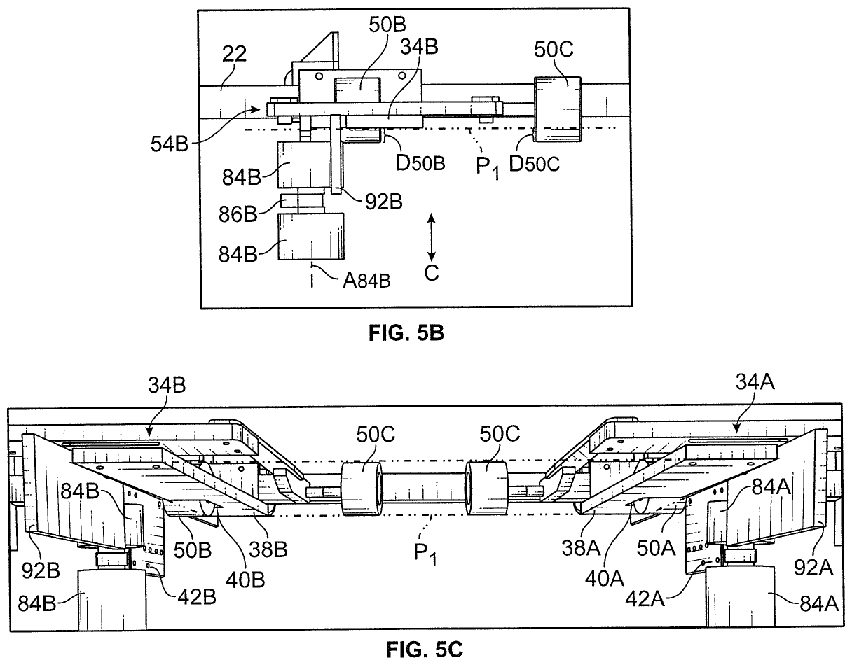

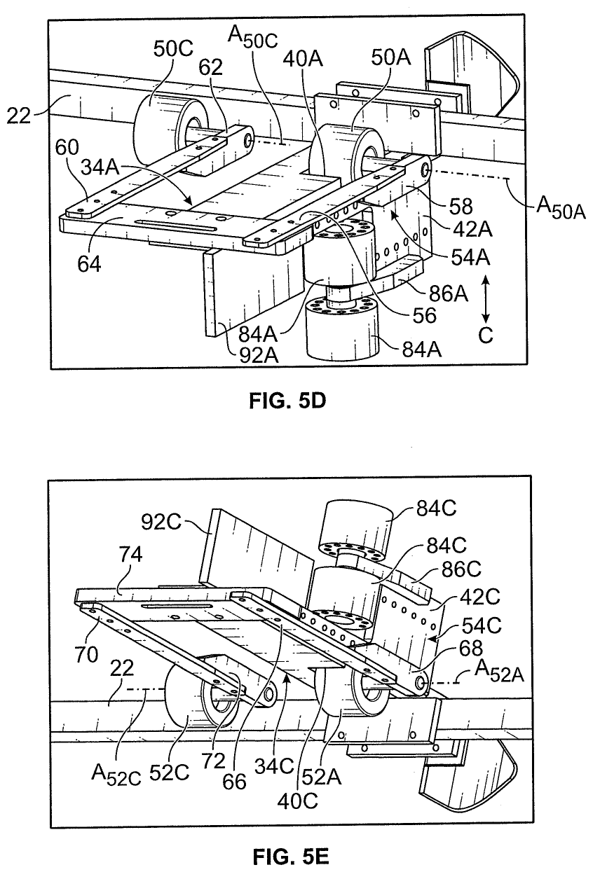

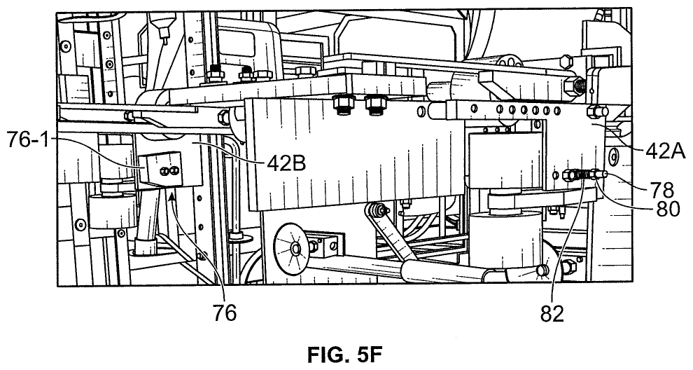

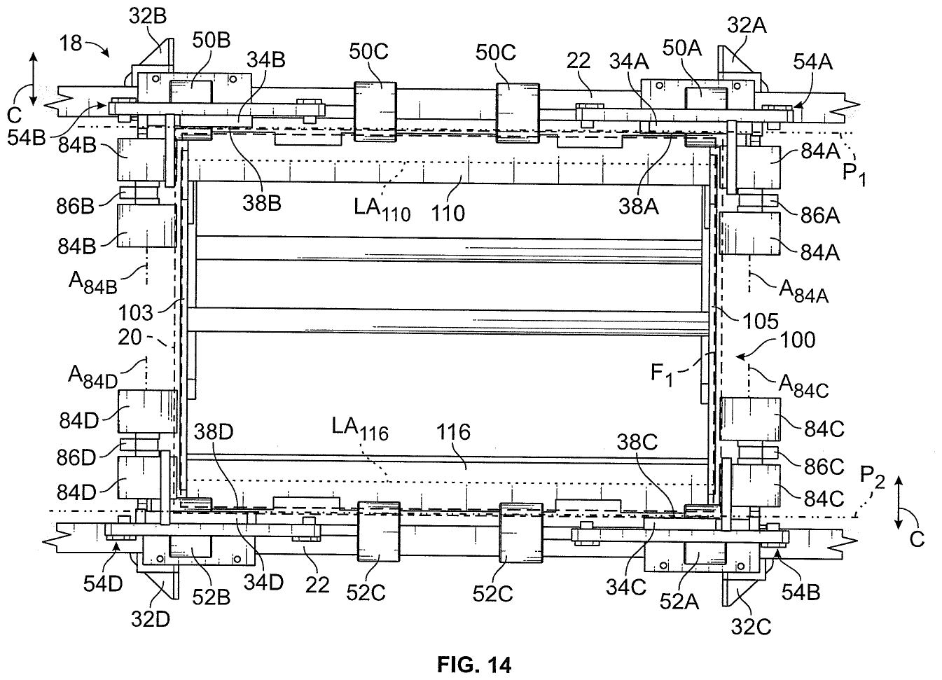

With reference to FIGS. 5A-5F and 14, the exemplary folding station 18 comprises a plurality of folding structures mounted therein, a portion of which collectively define an opening 20 (indicated with a dash-dot line in FIG. 14). The opening 20 comprises dimensions that substantially correspond to the first footprint F₁ (indicated with long dashed lines in FIG. 14; see also FIG. 7) of the mandrel assembly 100 with the forming elements 110, 116 in the home position, such that the opening 20 receives the mandrel assembly 100. The folding station 18 may comprise frame elements 22 that support the folding station 18 and are not discussed in further detail.

The folding station 18 comprises a first (upper) pair of curved folding shoes 32A, 32B; a second (lower) pair of curved folding shoes 32C, 32D; at least one first deck section, i.e., upper deck sections 34A, 34B; and at least one second deck section, i.e., lower deck sections 34C, 34D, all of which are mounted to the frame elements 22. The upper and lower deck sections 34A, 34B and 34C, 34D are spaced apart from each other. The upper deck sections 34A, 34B comprise a respective, substantially planar inner surface 38A, 38B and a respective curved back portion 36A, 36B. The lower deck sections 34C, 34D similarly comprise a respective, substantially planar inner surface 38C, 38D and a respective curved back portion 36C, 36D. The curved back portions 36A-36D may assist with smoothly folding the blank 200, as described herein. Although the example shown includes two separate first (upper) deck sections 34A, 34B and two separate second (lower) deck sections 34C, 34D, it should be understood that one or both of the upper and lower deck sections may comprise a single, continuous deck section.

With reference to FIGS. 5B, 5C, and 14, the inner surfaces 38A, 38B of the upper deck sections 34A, 34B (excluding the curved back portions 36A, 36B) define a first deck plane P₁, and the inner surfaces 38C, 38D of the lower deck sections 34C, 34D (excluding the curved back portions 36C, 36D) define a second deck plane P₂ (the deck planes P₁, P₂ are indicated with double dot-dash lines). The first and second deck planes P₁, P₂ may be substantially parallel with each other. As shown in FIG. 14, the first and second forming elements 110, 116 may comprise a respective longitudinal axis LA₁₁₀, LA₁₁₆, and the first and second deck planes P₁, P₂ may extend parallel to the longitudinal axes LA₁₁₀, LA₁₁₆ of the first and second forming elements 110, 116.

A first (upper) pair of linear folding shoes 42A, 42B are coupled to respective ones of the upper deck sections 34A, 34B, and a second (lower) pair of linear folding shoes 42C, 42D are coupled to respective ones of the lower deck sections 34C, 34D, as shown in FIG. 5A (see also FIGS. 5D and 5E). As shown in FIG. 16, the folding station 18 may optionally comprise one or more curved guides 88A, 88B coupled to the frame elements 22 that may assist with folding of the blank 200. In the example shown, one upper curved guide 88A is provided, but one or more additional upper curved guides may be provided. The folding station 18 comprises a pair of lower curved guides 88B (only one lower curved guide 88B is visible in FIG. 16).

At least one first horizontal roller is associated with the at least one first deck section, and at least one second horizontal roller is associated with the at least one second deck section. With reference to the example shown in FIGS. 5A-5E, a first horizontal roller 50A is associated with the upper deck section 34A, and a first horizontal roller 50B is associated with the at least one first deck section 34B (the first horizontal rollers 50A, 50B may be referred to herein as upper horizontal rollers). A second horizontal roller 52A is associated with the lower deck section 34C, and a second horizontal rollers 52B is associated with the lower deck section 34D (the second horizontal rollers 52A, 52B may be referred to herein as lower horizontal rollers). The upper horizontal rollers 50A, 50B may be laterally spaced apart from each other, and the lower horizontal rollers 52A, 52B may be laterally spaced apart from each other. One or more additional upper horizontal rollers 50C may optionally be positioned between the upper horizontal rollers 50A, 50B, and one or more additional lower horizontal rollers 52C may optionally be positioned between the lower horizontal rollers 52A, 52B. The upper and lower horizontal rollers 50A-50C and 52A-52C may be formed of a relatively hard polymer material, e.g., an acetal polymer.

With reference to FIGS. 5A, 5C, and 5D, the upper deck sections 34A, 34B include cutouts 40A, 40B that receive the upper horizontal rollers 50A, 50B, and the upper horizontal rollers 50A, 50B are movably mounted with respect to the upper deck sections 34A, 34B via respective flexing elements 54A, 54B, such that the upper horizontal rollers 50A, 50B are configured to deflect in a direction indicated by arrow C that is substantially perpendicular to the first deck plane P₁. With reference to the detailed top perspective view of the upper deck section 34A shown in FIG. 5D, the flexing element 54A may include a flexible rod or lever 56 to which the upper horizontal roller 50A is mounted, e.g., via a bracket 58 that may have an axle (not labeled) to which the horizontal roller 50A is rotatably mounted via a bearing, such that the horizontal roller 50A is able to rotate back and forth about a rotational axis A_{50A}. The additional upper horizontal roller 50C adjacent to the horizontal roller 50A may similarly be mounted to a flexible rod or lever 60, e.g., via a bracket 62, such that the additional upper horizontal roller 50C is able to rotate back and forth about a rotational axis A_{50C}. The rotational axes A_{50A}, A_{50C} may be parallel to each other and parallel to the first deck plane P₁ (see FIGS. 5B, 5C, and 14). In the example shown, the horizontal roller 50A is positioned slightly forward of the additional horizontal roller 50C. The rods 56, 60 may be coupled to the upper deck section 34A, e.g., via a plate 64 that extends between the rods 56, 60 and is coupled or fixed to the upper deck section 34A. The rods 56, 60 may be flexible to allow the horizontal rollers 50A, 50C to move or deflect up and down in the direction C as the mandrel assembly 100 and blank 200 pass underneath the horizonal rollers 50A, 50C, as described herein in more detail. The direction C is substantially perpendicular to the axes A_{50A}, A_{50C} (see FIGS. 5C and 14). A horizontal guide rail 92A, which may be coupled to the upper deck section 34A and the linear folding shoe 42A, provides additional stability to the plate 64, as well as helping to direct the finished tray 300, as described below. The structure of the flexing element 54B is substantially similar to the flexing element 54A, with the horizontal roller 50B and the adjacent additional horizontal roller 50C each comprising a rotational axis (not shown) that is parallel to the first deck plane P₁ and perpendicular to the direction C (see FIGS. 5A, 5B, and 14). A horizontal guide rail 92B may similarly be coupled to the upper deck section 34B and the linear folding shoe 42B.

With reference to FIGS. 5A and 5E, the lower deck sections 34C, 34D may include cutouts 40C, 40D that receive the lower horizontal rollers 52A, 52B, and the lower horizontal rollers 52A, 52B are movably mounted with respect to the lower deck sections 34C, 34D via respective flexing elements 54C, 54D, such that the lower horizontal rollers 52A, 52B are configured to deflect in the direction C that is substantially perpendicular to the second deck plane P₂. With reference to the detailed bottom perspective view of the lower deck section 34C shown in FIG. 5E, the flexing element 54C may include a flexible rod or lever 66 to which the lower horizontal roller 52A is mounted, e.g., via a bracket 68 that may have an axle (not labeled) to which the horizontal roller 52A is rotatably mounted via a bearing, such that the horizontal roller 52A is able to rotate back and forth about a rotational axis A_{52A}. The additional lower horizontal roller 52C adjacent to the horizontal roller 52A may similarly be mounted to a flexible rod or lever 70, e.g., via a bracket 72, such that the additional lower horizontal roller 52C is able to rotate back and forth about a rotational axis A_{52C}. The rotational axes A_{52A}, A_{52C} may be parallel to each other and parallel to the second deck plane P₂ (see FIG. 14). In the example shown, the horizontal roller 52A is positioned slightly forward of the additional horizontal roller 52C. The rods 66, 70 may be coupled to the lower deck section 34C, e.g., via a plate 74 that extends between the rods 66, 70 and is coupled or fixed to the lower deck section 34C. The rods 66, 70 may be flexible to allow the horizontal rollers 52A, 52C to move or deflect up and down in the direction arrow C (see FIGS. 5D and 14) as the mandrel assembly 100 and blank 200 pass above the horizonal rollers 52A, 52C, in which the direction C is substantially perpendicular to the rotational axes A_{52A}, A_{52C}. A horizontal guide rail 92C, which may be coupled to the lower deck section 34C and the linear folding shoe 42C, provides additional stability to the plate 74, as well as helping to direct the finished tray 300, as described below. The structure of the flexing element 54D is substantially similar to the flexing element 54C, with the horizontal roller 52B and the adjacent additional horizontal roller 52C each comprising a rotational axis (not shown) that is parallel to the second deck plane P₂ and perpendicular to the direction C (see FIGS. 5A and 14). A horizontal guide rail 92D may similarly be coupled to the lower deck section 34D and the linear folding shoe 42D.

With reference to the detailed view of FIG. 5B, the upper horizontal roller 50B extends beyond the first deck plane P₁, i.e., below, the first deck plane P₁ (as at least partially defined by the first deck section 34B) by a distance D_{50B}. The additional upper horizontal roller 50C adjacent to the horizontal roller 50B may similarly extend beyond, i.e., below, the first deck plane P₁ by a distance D_{50C}, in which the distances D_{50B}, D_{50C} may be substantially the same. As shown in FIGS. 5C and 14, the upper horizontal roller 50A and the additional upper horizontal roller 50C adjacent to the upper horizontal roller 50A similarly extend beyond, i.e., below, the first deck plane P₁ by a distance (not labeled) that is substantially the same as the distances D_{50B}, D_{50C}; and the lower horizontal rollers 52A, 52B and additional lower horizontal rollers 52C extend beyond, i.e., above, the second deck plane P₂ by a distance that is substantially the same as the distances D_{50B}, D_{50C}.

As shown in FIG. 14, the upper horizontal rollers 50A-50C are configured to contact the first forming element 110 as the mandrel assembly 100 advances forward into, or withdraws from, the folding station 18 and the first forming element 110 passes underneath the upper horizontal rollers 50A-50C. The lower horizontal rollers 52A-52C are similarly configured to contact the second forming element 116 as the mandrel assembly 100 advances forward into, or withdraws from, the folding station 18 and the second forming element 116 passes over the lower horizontal rollers 52A-52C. As described above with respect to FIGS. 5D and 5E, the flexing elements 54A-54D allow the upper and lower horizontal rollers 50A-50C and 52A-52C to move or deflect as the mandrel assembly 100 passes above or below.

With reference to the detailed view of FIG. 5F, the folding station 18 further comprises paddles that assist with formation of the tray 300 (see also FIG. 15). In the example shown, a paddle 76 is coupled to an inner surface of the linear folding shoe 42B. The paddle 76 comprises a curved portion 76-1 that curves inward, i.e., toward the linear folding shoe 42A on the opposite side. Although not visible, a paddle is also coupled to an inner surface of the linear folding shoe 42A via a bolt 78 passing through openings (not visible) in the paddle and folding shoe 42A and a nut 80 with a biasing element, e.g., a compression spring 82, sandwiched between the nut 80 and an outer surface of the linear folding shoe 42A. Although not visible, the paddle 76 is similarly coupled to the linear folding shoe 42B. As described herein, the biasing elements allows the paddles 76 to deflect from a home position to a deflected position, in which the curved portions 76-1 of the paddles 76 move outward, i.e., away from each other, to allow the completed tray 300 to pass by. After the tray 300 passes by, the biasing element biases the paddles 76 back to the home position, such that the curved portions 76-1 prevent the tray 300 from moving backward.

With reference to FIGS. 5A, 5B, and 14, the folding station 18 further comprises at least one first vertical roller, i.e., pairs of upper vertical rollers 84A, 84B, and at least one second vertical roller, i.e., pairs of lower vertical rollers 84C, 84D, in which the upper vertical rollers 84A, 84B are spaced apart vertically from the lower vertical rollers 84C, 84D. The upper vertical rollers 84A, 84B are mounted to a respective one of the linear folding shoes 42A, 42B, e.g., via a bracket 86A, 86B, and the lower vertical rollers 84C, 84D are mounted to a respective one of the linear folding shoes 42C, 42D, e.g., via a bracket 86C, 86D (see also FIGS. 5D and 5E). The pair of upper vertical rollers 84A are coaxial with each other and have a rotational axis A_{84A}, and the pair of upper vertical rollers 84B are similarly coaxial with each other and have a rotational axis A_{84B}, as shown in FIG. 14. The pair of lower vertical rollers 84C are coaxial with each other and have a rotational axis A_{84C}, and the pair of lower vertical rollers 84D are similarly coaxial with each other and have a rotational axis A_{84D}, as shown in FIG. 14.

The axes A_{84A}-A_{84D} of the upper vertical rollers 84A-84D are substantially perpendicular to the first and second deck planes P₁, P₂ and to the longitudinal axes LA₁₁₀, LA₁₁₆ of the first and second forming elements 110, 116. As best seen in FIGS. 5A and 5C, the linear folding shoes 42A-42D are positioned laterally outward of the respective horizontal guide rails 92A-92D, with the upper and lower vertical rollers 84A-84D being positioned between respective ones of the linear folding shoes 42A-42D and the horizontal guide rails 92A-92D. The upper and lower vertical rollers 84A-84D may extend slightly beyond, i.e., laterally inward, a plane (not labeled) defined by the horizontal guide rails 92A-92D and may be formed from a relatively soft polymer (e.g., polyurethane), as compared to the upper and lower horizontal rollers 50A-50C and 52A-52C. The upper and lower vertical rollers 84A, 84C may be coaxial with each other, and the upper and lower vertical rollers 84B, 84D may be coaxial with each other, such that the vertical rollers 84A-84D provide compression to complete formation of the tray 300, as described herein.

With reference to FIGS. 3, 6, and 16, a track assembly 400 is shown, which supports the mandrel assembly 100 and aligns the mandrel assembly 100 with respect to the folding station 18. The track assembly 400, which may be coupled to the frame elements 22, comprises a pair of upper rails 402, 404, a pair of middle rails 406, 408, and a pair of lower rails 410, 412, which collectively define a track within which the mandrel assembly 100 rides. As best seen in FIG. 16, the rollers (only roller 176A is visible) of the mandrel assembly 100 are received between the upper rails 402, 404 and middle rails 406, 408. With reference to the first rail 150, the second portion 153 is received between the middle rail 408 and the lower rail 412. The second portion (not visible) of the second rail 152 is similarly received between the middle rail (not visible) and the lower rail 410. A pair of mandrel support wheels (only wheel 414 is visible in FIG. 16) further support the mandrel assembly 100 as the mandrel assembly 100 enters the folding station 18. The actuator 180 is configured to move, i.e., advance and withdraw, the mandrel assembly 100 relative to the folding station 18. As shown in FIGS. 7 and 16, the actuator 180 may be coupled to the mandrel assembly 100, e.g., to the additional bar 122B via a coupling 182 that fits over and rotates about the additional bar 122B, in which the coupling 182 may comprise a sleeve that receives the additional bar 122B. As described herein, the actuator 180 drives the mandrel assembly 100 forward (i.e., advances) in a first linear direction, as indicated with arrow D in FIG. 16, toward the folding station 18 and pulls the mandrel assembly 100 back (i.e., withdraws) in a second linear direction, as indicated with arrow E, in a linear, reciprocating motion, in which the second direction D is opposite the first direction E (see also FIGS. 19A, 20A, and 22A).

FIG. 15 is a front view of another exemplary mandrel assembly 100′ and folding station 18′, in accordance with the present disclosure. Except as described herein, the mandrel assembly 100′ may be substantially similar to the mandrel assembly 100 depicted in FIGS. 7-13, and the folding station 18′ may be substantially similar to the folding station 18 depicted in FIGS. 5A-5F. The mandrel assembly 100′ may comprise a first side plate 102′ and a second side plate 104′ spaced apart from the first side plate 102′; a first bar (not visible) and a second bar (not visible) that are each coupled to, and extend between, the first and second side plates 102′, 104′, with the second bar being spaced apart from the first bar; a first forming element 110′ pivotally coupled to the first bar; and a second forming element 116′ pivotally coupled to the second bar. The first side plate 102′ may comprise an assembly with a first main plate 103′ coupled to a first rail 150′, and the second side plate 104′ may similarly comprise an assembly with a second main plate 105′ coupled to a second rail 152′. The mandrel assembly 100′ may comprise one or more additional bars (only bar 122B′ is labeled in FIG. 15) extending between the first and second side plates 102′, 104′. Support brackets 158′, 160′ may extend at an angle between respective ones of the first and second side plates 102′, 104′ and the first and second rails 150′, 152′.

The first and second bars (not visible) may be substantially similar to the first and second bars 106, 108 described herein and may be fixed to the first and second side plates 102′, 104′. The first and second forming elements 110′, 116′ may be substantially similar to the first and second forming elements 110, 116 described herein, except that the first and second forming elements 110′, 116′ shown in FIG. 15 each include only two forming sections 110B′, 116B′, respectively. The mandrel assembly 100′ may be configured to form a tray having different dimensions, as compared to the tray 300 (see FIGS. 2A-2C) formed by the mandrel assembly 100 shown in FIGS. 7-13. The first and second forming elements 110′, 116′ of the mandrel assembly 100′ shown in FIG. 15 may be coupled to a respective one of the first bar or the second bar via one or more fasteners, such as a partially threaded bolt 130′, 132′ and are configured to rotate with respect to the first or second bar, respectively, from a home position to a collapsed position. The mandrel assembly 100′ may comprise at least one biasing element, i.e., compression springs 126′, 128′, that are configured to bias the first and second forming elements 110′, 116′, respectively toward the home position as described in detail with respect to the mandrel assembly 100 shown in FIG. 7. Brackets 162A, 162B may be coupled to a respective one of the first main plate 103′ or the second main plate 105′ to support vacuum cups 142. The mandrel assembly 100′ may comprise a support assembly (not labeled) substantially similar to that described herein with respect to the mandrel assembly 100.

The exemplary folding station 18′ comprises a plurality of folding structures mounted therein, a portion of which collectively define an opening 20′ (indicated with a dash dot line in FIG. 15). The opening 20′ comprises dimensions that substantially correspond to the footprint F_{1′} of the mandrel assembly 100 with the forming elements 110′, 116′ in the home position, such that the opening 20′ receives the mandrel assembly 100′. Frame elements (not labeled) may be provided that support the folding station 18′.

Similar to the folding station 18, the folding station 18′ of FIG. 15 comprises upper and lower pairs of curved folding shoes (not visible); at least one first deck section, i.e., upper deck sections 34A′, 34B′; and at least one second deck section, i.e., lower deck sections 34C′, 34D′, all of which are mounted to frame elements (not shown). The upper and lower deck sections 34A′, 34B′ and 34C′, 34D′ are spaced apart from each other. The upper deck sections 34A′, 34B′ comprise a respective, substantially planar inner surface 38A′, 38B′ and a respective curved back portion (not visible). The lower deck sections 34C′, 34D′ similarly comprise a respective, substantially planar inner surface 38C′, 38D′ and a respective curved back portion (not visible). Although the example shown includes two separate first (upper) deck sections 34A′, 34B′ and two separate second (lower) deck sections 34C′, 34D′, it should be understood that one or both of the upper and lower deck sections may comprise a single, continuous deck section. The inner surfaces 38A′, 38B′ of the upper deck sections 34A′, 34B′ (excluding the curved back portions) define a first deck plane P_{1′}, and the inner surfaces 38C′, 38D′ of the lower deck sections 34C′, 34D′ (excluding the curved back portions) define a second deck plane P_{2′} (the deck planes P_{1′}, P_{2′} are indicated with double dot-dash lines). The first and second deck planes P_{1′}, P_{2′} may be substantially parallel with each other and may extend parallel to longitudinal axes LA_{110′}, LA_{116′} of the first and second forming elements 110′, 116′.

The folding station 18′ of FIG. 15 further comprises upper and lower pairs of linear folding shoes (only the lower pair of linear folding shoes 42C′, 42D′ are visible); upper and lower horizontal guide rails (only the upper horizontal guide rails 92A′, 92B′ are visible); one or more first (upper) horizontal rollers 50A′, 50B′ associated with a respective one of the upper deck sections 34A′, 34B′ and spaced apart from each other; and one or more second (lower) horizontal rollers 52A′, 52B′ associated with a respective one of the lower deck sections 34C′, 34D′ and spaced apart from each other. Because the mandrel assembly 100′ of FIG. 15 is smaller than the mandrel assembly 100 of FIG. 14, the folding station 18′ of FIG. 15 lacks additional horizontal rollers positioned between the upper and lower horizontal rollers 50A′, 50B′ and 52A′, 52B′. The upper and lower deck sections 34A′-34D′ include cutouts 40A′-40D′ that receive respective ones of the upper and lower horizontal rollers 50A′, 50B′ and 52A′, 52D′. The upper and lower horizontal rollers 50A′, 50B′ and 52A′, 52B′ are movably mounted with respect to the upper deck sections 34A′, 34B′ and lower deck sections 34C′, 34D′ via respective flexing elements (not visible), which may be substantially similar to the flexing elements 54A-54D described herein, such that the upper and lower horizontal rollers 50A′, 50B′ and 52A′, 52B′ extend beyond, i.e., below or above, a respective one of the first or the second deck plane P_{1′}, P_{2′} by a respective distance (not labeled; see distances D_{50B}, D_{50C} in FIG. 5B) and are able move or deflect up and down in a direction (see arrow C in FIG. 14) that is substantially perpendicular to the first and second deck planes P_{1′}, P_{2′}. The upper and lower horizontal rollers 50A′, 50B′ and 52A′, 52B′ also rotate back and forth about a respective rotational axis (not labeled) that is parallel to the first and second deck planes P_{1′}, P_{2′}. The upper and lower horizontal rollers 50A′, 50B′ and 52A′, 52B′ are configured to contact a respective one of the first or the second forming element 110′, 116′ as the mandrel assembly 100′ advances forward and withdraws. As described above with respect to the mandrel assembly 100 and folding station 18, the flexing elements allow the upper and lower horizontal rollers 50A′, 50B′ and 52A′, 52B′ to move or deflect in a direction that is substantially perpendicular to the first and second deck planes P_{1′}, P_{2′} as the mandrel assembly 100 advances forward and withdraws.

The folding station 18′ of FIG. 15 further comprises upper and lower paddles 76′ that assist with formation of the tray 300. The paddles 76′ are coupled to an inner surface of a respective one of the linear folding shoes 42C′, 42D′, as described herein. Each paddle 76′ comprises a curved portion 76-1′ that curves inward, i.e., toward the opposing linear folding shoe 42C′, 42D′, and may be substantially identical to the paddles 76 of the folding station 18. As described herein, the paddles 76′ deflect outward, i.e., away from each other, from a home position to a deflected position to allow a completed tray to pass by and are biased back to the home position to prevent the tray from moving backward.

The folding station 18′ further comprises at least one first (upper) vertical roller 84A′, 84B′ and at least one second (lower) vertical roller 84C′, 84D′, in which the upper vertical rollers 84A′, 84B′ are spaced apart from the lower vertical rollers 84C′, 84D′. Because the folding station 18′ and mandrel assembly 100′ of FIG. 15 are smaller than the folding station 18 and mandrel assembly 100 of FIG. 14, the upper and lower vertical rollers 84A′, 84B′ and 84C′, 84D′ both comprise only a single roller, as opposed to the pairs of coaxial vertical rollers 84A, 84B and 84C, 84D shown in FIG. 14. The upper and lower vertical rollers 84A′, 84B′ and 84C′, 84D′ are mounted to a respective one of the linear folding shoes 42C′, 42D′ and each have a rotational axis (not labeled) that is substantially perpendicular to the first and second deck planes P_{1′}, P_{2′} and to the longitudinal axes LA_{110′}, LA_{116′} of the first and second forming elements 110′, 116′. The upper and lower vertical rollers 84A′, 84C′ may be coaxial with each other, and the upper and lower vertical rollers 84B′, 84D′ may be coaxial with each other, such that the vertical rollers 84A′-84D′ provide compression to complete formation of the tray, as described herein.

With reference to FIGS. 17-22, formation of a tapered tray 300 (see FIGS. 2A-2C) from a blank 200 (see FIG. 1) will be described. The blank 200 may be substantially similar to the blank 200 shown in FIG. 1, and like reference numbers are used to indicate the corresponding components. Likewise, the folding station 18 and mandrel assembly 100 may be substantially similar to that shown in FIGS. 5A-5F and 7-14, and like reference numbers are used to indicate the corresponding components.

In FIG. 17, the blank 200 is placed in the feed position, e.g., by the hopper assembly 16 (see FIGS. 3 and 4), in front of the mandrel assembly 100, and the actuator 180 advances the mandrel assembly 100 from a withdrawn position to a first position, in which the mandrel assembly 100 engages the bottom panel 202 of the blank 200 and begins to move the blank 200 toward the folding station 18 (not visible in FIG. 17; see FIGS. 5A and 18-22). The vacuum cups 142 may engage portions of the bottom panel 202 of the blank 200 to secure the blank 200 in place. A glue or adhesive 266 may be applied in one or more strips and/or patches to portions of an inner surface of the third and fourth side panels 208, 210 (only the adhesive 266 applied to the third side panel 208 is visible) by one or more glue applicators (not shown), which may be located, for example, in or adjacent to the feeding station 14 (see FIG. 3). As described herein, the adhesive 266 is used to adhere the third and fourth side panels 208, 210 to the end flaps 212, 214, 216, 218. It can be seen in FIG. 17 that the first footprint F₁ of the mandrel assembly 100, i.e., the footprint F₁ collectively defined by the first and second forming sections 110B, 116B and the front edges of the first and second side plates 102, 104 as described herein (see FIG. 7), substantially corresponds to at least one of the length L₂₀₂ or the width W₂₀₂ of the bottom panel 202 of the blank 200 (see FIG. 1). In the example shown in FIG. 17, the first width W_{F1} of the first footprint F₁ substantially corresponds to the width W₂₀₂ of the bottom panel 202 of the blank 200 (see also FIGS. 1 and 7). The length L₂₀₂ of the blank 200 may be greater than the first length L_{F1} of the first footprint F₁ to accommodate the combined thickness of the third and fourth side panels 208, 210 and the end flaps 212, 214, 216, 218 (see also FIGS. 1 and 7).

As shown in FIG. 18, the actuator 180 advances the mandrel assembly 100 and the blank 200 toward the folding station 18 in the forward direction D until the mandrel assembly 100 begins to enter the opening 20 (not visible; see FIGS. 5A and 14) of the folding station 18. The upper and lower pairs of curved folding shoes 32A, 32B and 32C, 32D (only folding shoes 32A and 32C are visible in FIG. 18; see FIGS. 5A and 19) are positioned opposite each other, such that as the first and second end flaps 212, 214 and 216, 218 contact respective ones of the upper and lower pairs of curved folding shoes 32A, 32B and 32C, 32D, the first and second end flaps 212, 214 and 216, 218 begin substantially simultaneously folding inward toward each other along the respective fold lines 212A, 214A and 216A, 218A (see FIG. 1). The curvature of the curved folding shoes 32A-32D may assist with smoothly folding the first and second end flaps 212, 214 and 216, 218 inward. The first and second side panels 204, 206 also begin folding inward toward each other and toward the bottom panel 202 along the respective fold lines 204A, 204B (see FIG. 1). The first side panel 204 may begin folding inward as it contacts the upper curved guide 88A, along with the curved back portions 36A, 36B of the upper deck sections 34A, 34B (not visible; see FIGS. 5A, 19, and 19A). The second side panel 206 similarly begins folding inward as it contacts the curved back portions 36C, 36D of the lower deck sections 34C, 34D (not visible; see FIGS. 5A, 19, and 19A). The curved back portions 36A-36D of the upper and lower deck sections 34A-34D assist with smoothly folding the first and second side panels 204, 206. Further, the third and fourth side panels 208, 210 contact the lower curved guides 88B (only the third side panel 208 and one of the lower curved guides 88B are visible in FIG. 18; see FIG. 17) and begin folding inward toward each other and toward the bottom panel 202 along the respective fold lines 208A, 210A (see FIG. 1).

With reference to FIGS. 19 and 19A, the actuator 180 advances the mandrel assembly 100 and the partially-folded blank 200 forward in the direction D to a second position within the folding station 18. Continued contact between the upper and lower pairs of curved folding shoes 32A, 32B and 32C, 32D and the first and second end flaps 212, 214 and 216, 218 (only the end flaps 212, 214, and 216 are visible in FIGS. 19 and 19A; see FIG. 18) causes the first and second end flaps 212, 214 and 216, 218 to continue folding inward until they reach a final folded position, in which the first end flaps 212, 214 are orientated substantially perpendicular to the first side panel 204 and the second end flaps 216, 218 are oriented substantially perpendicular to the second side panel 206. At the same time as the first and second end flaps 212, 214 and 216, 218 are reaching their final folded position, the first side panel 204 contacts the at least one first deck section, i.e., the upper deck sections 34A, 34B (only deck section 34A is visible in FIG. 19A; see FIG. 5A), and the second side panel 206 contacts the at least one second deck section, i.e., the lower deck sections 34C, 34D (only deck section 34C is visible in FIGS. 19 and 19A; see FIG. 5A). The upper and lower deck sections 34A, 34B and 34C, 34D are positioned opposite each other, such that the first and second side panels 204, 206 substantially simultaneously fold inward toward each other to a first folded position. The third side panel 208 also contacts the upper and lower linear folding shoes 42A, 42C, causing the third side panel 208 to fold further inward; and fourth side panel 210 contacts the upper and lower linear folding shoes 42B, 42D (not visible in FIGS. 19 and 19A; see FIG. 5A), causing the fourth side panel 210 to fold further inward. The upper and lower linear folding shoes 42A, 42B, and 42C, 42D are positioned opposite each other, such that as the third and fourth side panels 208, 210 contact the linear folding shoes 42A-42D, the third and fourth side panels 208, 210 substantially simultaneously fold inward toward each other.

In particular, with reference to FIG. 19A, contact with the respective inner surfaces 38A, 38B and 38C, 38D of the upper and lower deck sections 34A, 34B and 34C, 34D (only deck sections 34A, 34C and their respective inner surfaces 38A, 38C are visible in FIG. 19A; see FIG. 5A) causes the first and second side panels 204, 206 to fold inward to the first folded position, in which the first and second side panels 204, 206 are substantially parallel to each other and substantially perpendicular to the bottom panel 202, i.e., the first and second side panels 204, 206 are positioned at about a 90 degree angle with respect to the bottom panel 202. As the mandrel assembly 100 advances forward in the views shown in FIGS. 17-19 and 19A, the first and second forming elements 110, 116 are in the home position, which corresponds to the position of the first and second forming elements 110, 116 shown in FIGS. 7, 8, 11A, and 12A. Thus, the first side panel 204 folds over the first substantially planar outer edge 112A-1 of the first forming element 110 along a junction between the first side panel 204 and the bottom panel 202, i.e., along the fold line 204A (see FIG. 1); and the second side panel 206 folds over the second substantially planar outer edge 118A-1 of the second forming element 116 along a junction between the second side panel 206 and the bottom panel 202, i.e., along the fold line 206A (see FIG. 1).

With reference to the first side plate 102 shown in FIGS. 19 and 19A, the track assembly 400 (see also FIGS. 6 and 16) supports and aligns the mandrel assembly 100 with respect to the folding station 18, such that when the mandrel assembly 100 engages the bottom panel 202 of the blank 200 and enters the folding station 18, the front edge of the first side plate 102, which is collectively defined by the front edge 103A of the first main plate 103 and the front edge 150A of the first rail 150 in the illustrated example, is perpendicular to (i.e., positioned at about a 90 degree angle) the first and second deck planes P₁, P₂; and the upper and lower edges of the first side plate 102, as respectively defined by the upper edge 103B of the first main plate 103 and the lower edge 150C of the first rail 150 in the illustrated example, are parallel to the first and second deck planes P₁, P₂. Although not visible, the front edge of the second side plate 104, which is collectively defined by the front edge 105A of the second main plate 105 and the front edge 152A of the second rail 152 in the illustrated example, is also perpendicular to the first and second deck planes P₁, P₂; and the upper and lower edges of the second side plate 104, as respectively defined by the upper edge 105B of the second main plate 105 and the lower edge 152C of the second rail 152, are also parallel to the first and second deck planes P₁, P₂ (see FIGS. 7, 8, and 14).

With reference to FIGS. 20 and 20A, the actuator 180 advances the mandrel assembly 100 and the partially-folded blank 200 forward in the direction D to a third position within the folding station 18, in which the first and second side panels 204, 206 are folded further inward toward each other and toward the bottom panel 202 to a second folded position. When the mandrel assembly 100 is in the second position as shown in FIGS. 19 and 19A, the mandrel assembly 100 and blank 200 have not yet encountered the upper and lower horizontal rollers 50A-50C and 52A-52C (only the upper horizontal roller 50A, one of the additional upper horizontal rollers 50C, the lower horizontal roller 52C, and one of the additional lower horizontal rollers 52C is visible in FIG. 19A; see FIG. 14). When the mandrel assembly 100 moves into the third position as shown in FIGS. 20 and 20A, the first and second forming elements 110, 116 pass below the upper horizontal rollers 50A, 50C and above the lower horizontal rollers 52A, 52B, causing the first side panel 204 to contact the upper horizontal rollers 50A, 50C and causing the second side panel 206 to contact the lower horizontal rollers 52A, 52C.

As discussed above with respect to FIGS. 11A, 11B, 12A, and 12B, the first and second forming elements 110, 116 are prevented from rotating from the home position in a direction opposite the direction A or B, respectively, by engagement with the first and second bars 106, 108. Thus, the first and second forming elements 110, 116 cause the upper and lower horizontal rollers 50A-50C and 52A-52C to move outward via the flexing elements 54A-54D (only flexing elements 54A, 54C are visible in FIG. 20A; see FIGS. 5A and 14). In particular, with reference to FIGS. 5D, 5E, and 20A, the rods 56, 60 (only rod 60 is visible in FIG. 20A) to which the upper horizontal rollers 50A, 50C are coupled flex outward from the upper deck section 34A in the direction C perpendicular to the first deck plane P₁ to allow the first forming element 110 to pass by (the rod 60 in a flexed position is indicated with reference numeral 60′ in FIG. 20A). Likewise, the rods 66, 70 (only rod 70 is visible in FIG. 20A) to which the lower horizontal rollers 52A, 52C are coupled flex outward from the lower deck section 34C in the direction C perpendicular to the second deck plane P₂ to allow the second forming element 116 to pass by (the rod 70 in a flexed position is indicated with reference numeral 70′ in FIG. 20A). The upper and lower horizontal rollers 50A, 50C and 52A, 52C also rotate about their respective rotational axes A_{50A}, A_{50C}, and A_{52A}, A_{52C} (see FIGS. 5D and 5E) as the first and second forming elements 110, 116 pass by. Although not visible in FIG. 20A, the upper horizontal roller 50B and the lower horizontal roller 52B, along with the additional upper and lower horizontal rollers 50C, 52C adjacent thereto, similarly move outward via their respective flexing elements 54B, 54D and rotate about their respective rotational axes to allow the first and second forming elements 110, 116 to pass by.

With continued reference to FIG. 20A, after the first and second forming elements 110, 116 pass by, the upper and lower horizontal rollers 50A, 50C and 52A, 52C contact the first and second side panels 204, 206, respectively. Because the first and second side panels 204, 206 are not yet fixed in place with respect to the bottom panel 202, the rods to which the upper horizontal rollers 50A, 50C are coupled (only rod 60′ is visible in FIG. 20A) begin to move back to an unflexed position (as shown in FIG. 19A) and bias the upper horizontal rollers 50A, 50C inward, i.e., toward the lower deck section 34C, in the direction C perpendicular to the first deck plane P₁; and the rods to which the lower horizontal rollers 52A, 52C are coupled (only rod 70′ is visible in FIG. 20A) begin to move back to an unflexed position (as shown in FIG. 19A) and bias the lower horizontal rollers 52A, 52C inward, i.e., toward the upper deck section 34A in the direction C perpendicular to the second deck plane P₂. This movement of the upper and lower horizontal rollers 50A, 50C and 52A, 52C causes the first and second side panels 204, 206 to fold further inward, i.e., the first side panel 204 moves toward the lower deck section 34C and the second side panel 206 moves toward the upper deck section 34A (indicated as a first tapered side panel 204′ and a second tapered side panel 206′, respectively) with respect to the bottom panel 202 to the second folded position.

With reference to the inset I of FIG. 20A, when the first tapered side panel 204′ is in the second folded position, the first tapered side panel 204′ comprises a first inner angle α_{204′} with respect to the bottom panel 202 that is less than 90 degrees. With reference to the inset II of FIG. 20A, when the second tapered side panel 206′ is in the second folded position, the second tapered side panel 206′ similarly comprises a second inner angle α_{206′} with respect to the bottom panel 202 that is less than 90 degrees. The inner angles α_{204′}, α_{206′} may be substantially equal and may correspond to the inner angles α_{304′}, α_{306′} of the first and second sidewalls 304, 306 of the finished tray 300 (see FIG. 2B). In some examples, the inner angles α_{204′}, α_{206′} may be between about 85 degrees to about 89 degrees with respect to the bottom panel 202, and in other examples, the inner angles α_{204′}, α_{206′} may be between about 85 degrees to about 87 degrees with respect to the bottom panel 202.

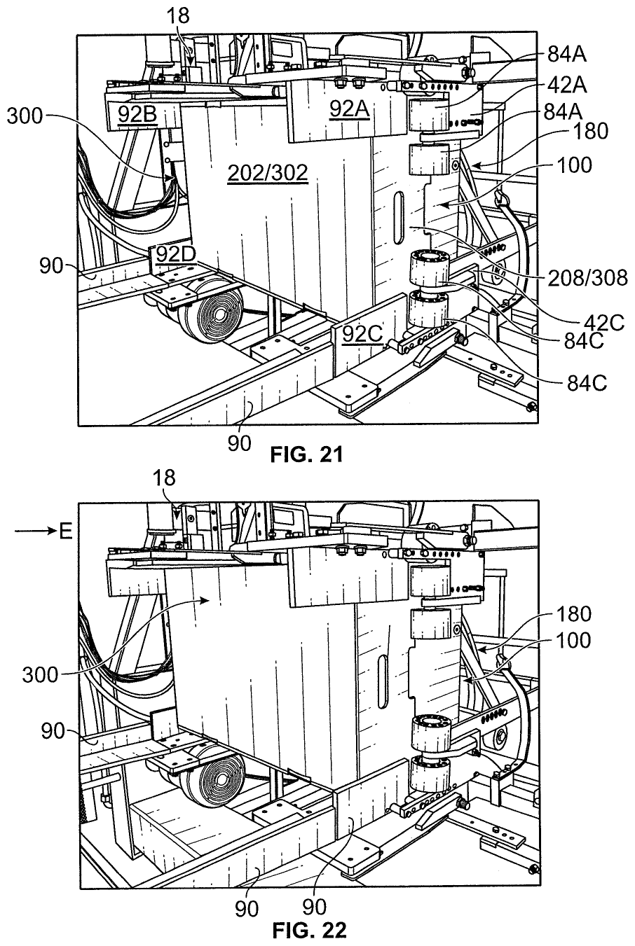

With reference to FIG. 21, the actuator 180 advances the mandrel assembly 100 and the partially-folded blank 200 forward in the direction D (see FIGS. 20 and 20A) to a fourth position within the folding station 18, in which the third and fourth side panels 208, 210 (only the third side panel 208 is visible in FIG. 21; see FIGS. 1 and 17) are coupled to the first and second tapered side panels 204′, 206′ (not visible in FIG. 21; see FIGS. 20A and 22A) via the first and second end flaps 212, 214, 216, 218 to form the completed tapered tray 300. With reference to FIGS. 17-20 as described above, as the actuator 180 advances the mandrel assembly 100 and blank 200 into the folding station 18, the first end flaps 212, 214 fold inward toward each other, the second end flaps 216, 218 fold inward with each other, and the first end flaps 212, 214 move inward toward the second end flaps 216, 218 as the first and second side panels 204, 206 are folded inward. The third side panel 208, which includes adhesive 266 applied to the inner surface thereof, is substantially simultaneously folded inward toward the fourth side panel 210, and when the mandrel assembly 100 reaches the fourth position shown in FIG. 21, the third side panel 208 contacts the upper and lower vertical rollers 84A, 84C, which compress the third side panel 208 against the first and second end flaps 212, 216 to secure the third side panel 208 to the first and second tapered side panels 204′, 206′ via being directly secured to the first and second end flaps 212, 216. Specifically, the adhesive 266 applied to the inner surface of the third side panel 208 contacts and becomes adhered to outer surfaces of the first and second end flaps 212, 216 to form the third sidewall 308 of the tapered tray 300 (see FIGS. 2A and 2C). Although not visible, the upper and lower vertical rollers 84B, 84D (see FIG. 14) similarly compress the fourth side panel 210 against the first and second end flaps 214, 218 (see FIGS. 1 and 17) to secure the fourth side panel 210 to the first and second tapered side panels 204′, 206′, i.e., by adhering the inner surface of the fourth side panel 210 to outer surfaces of the first and second end flaps 214, 218 to form the fourth sidewall 310 of the tapered tray 300 (see FIGS. 2A and 2C). The upper and lower vertical rollers 84A-84D rotate about their respective axes A_{84A}-A_{84D} (see FIG. 14) as the third and fourth side panels 208, 210 pass by. The upper and lower vertical rollers 84A-84D are positioned opposite each other, such that coupling of the third and fourth side panels 208, 210 to the first and second tapered side panels 204′, 206′ occurs substantially simultaneously. Coupling of the third and fourth side panels 208, 210 to the first and second tapered side panels 204′, 206′ creates corners of the tapered tray 300 and fixes the inner angles α_{204′}, α_{206′} (see insets I and II in FIG. 20A) of the first and second tapered side panels 204′, 206′ with respect to the bottom panel 202 of the blank 200, which defines the inner angles α_{304′}, α_{306′} of the first and second sidewalls 304, 306 with respect to the bottom 302 of the completed tapered tray 300 (see FIGS. 2A-2C).

As the mandrel assembly 100 moves to the fourth position, the third and fourth side panels 208, 210 contact the curved portion 76-1 of the paddles 76 (not visible; see paddle 76 in FIG. 5F and paddles 76-1′ in FIG. 15) coupled to the linear folding shoes 42A-42D (only linear folding shoes 42A, 42C are visible in FIG. 21; see FIG. 5A), which causes the paddles 76 to move from the home position to the deflected position to allow the third and fourth side panels 208, 210 to pass by. After the third and fourth side panels 208, 210 pass by, the paddles 76 are biased back to the home position, such that the curved portions 76-1 are positioned behind the third and fourth side panels 208, 210 and the completed tray 300 is prevented from moving backward when the mandrel assembly 100 withdraws, as described with respect to FIGS. 22 and 22A. The horizontal guide rails 92A-92D help to direct the finished tray 300 toward and onto the receiving rails 90.

As described herein, after the tapered tray 300 is completed, the width W₃₁₂ or the length L₃₁₂ of the opening 312 of the tray 300 is less than the width W₃₀₂ or the length L₃₀₂ of the bottom 302 of the tray 300 (see FIGS. 2A-2C), in which the width W₃₀₂ and length L₃₀₂ of the bottom 302 of the tray 300 are defined by the width W₂₀₂ and length L₂₀₂ of the bottom panel 202 of the blank 200 (see FIG. 1). Also as described herein, when the first and second forming elements 110, 116 are in the home position, as shown in FIGS. 7 and 20A, the first footprint F₁ of the mandrel assembly 100 substantially corresponds to at least one of the length L₂₀₂ or the width W₂₀₂ of the bottom panel 202 of the blank 200 (see FIG. 1). In the particular example shown in FIG. 20A, the first width W_{F1} of the first footprint F₁ corresponds to the width W₃₀₂ of the bottom 302 of the tapered tray 300, with the width W₃₁₂ of the opening 312 of the tray 300 being less than the first width W_{F1} and less than the width W₃₀₂ of the bottom 302 of the tray 300 due to the tapering of the first and second tapered side panels 204′, 206′. Because the first and second tapered side panels 204′, 206′ are adhered to the third and fourth side panels 208, 210 in the finished tapered tray 300, the first width W_{F1} must be reduced in order for the mandrel assembly 100 to withdraw from the tapered tray 300 without causing damage.

With reference to FIGS. 22 and 22A, the actuator 180 withdraws the mandrel assembly 100 in the direction E to remove the mandrel assembly 100 from the completed tapered tray 300. Engagement between the first tapered side panel 204′ and the first forming element 110, e.g., between an inner surface of the first tapered side panel 204′ and the first substantially planar outer edge 112A-1 of the first forming element 110, causes the first forming element 110 to rotate relative to the first bar 106 in the direction A from the home position to the collapsed position (see also FIGS. 11A and 11B). Engagement between the second tapered side panel 206′ and the second forming element 116, e.g., between an inner surface of the second tapered side panel 206′ and the second substantially planar outer edge 118A-1 of the second forming element 116, causes the second forming element 116 to rotate relative to the second bar 108 in the direction B (see also FIG. 12B) from the home position to the collapsed position, such that the mandrel assembly 100 comprises the second footprint F₂, in which the second footprint F₂ is smaller than the first footprint F₁ (see FIGS. 7 and 13). The second width W_{F2} and the second length L_{F2} of the second footprint F₂ substantially correspond to, or are less than, the corresponding width W₃₁₂ and length L₃₁₂ of the opening 312 of the tapered tray 300. In the example shown in FIGS. 20A and 22A, when the first and second forming elements 110, 116 move from their home positions to their collapsed positions, the second width W_{F2} is less than both the first width W_{F1} and the width W₃₀₂ of the bottom 302 of the tapered tray 300, and substantially corresponds to the width W₃₁₂ of the opening 312 of the tapered tray 300, such that the mandrel assembly 100 is able to withdraw from the tapered tray 300 in the direction E toward the withdrawn position in preparation for folding a new blank (see FIG. 17).

Once the mandrel assembly 100 withdraws from the tapered tray 300, the first and second forming elements 110, 116 are biased back to their respective home positions (see FIGS. 11A and 12A), e.g., via the compression springs 126, 128 (see FIG. 7) as described herein. As the mandrel assembly 100 continues withdrawing in the direction E, the first substantially planar outer edge 112A-1 of the first forming element 110 contacts the upper horizontal rollers 50A-50C, causing the upper horizontal rollers 50A-50C to move outward via the flexing elements 54A, 54B as shown in FIG. 20A and rotate about their respective axes A_{50A}, A_{50C} to allow the first forming element 110 to pass by (see also FIGS. 5A and 14). The second substantially planar outer edge 118A-1 of the second forming element 116 likewise contacts the lower horizontal rollers 52A-52C, which move outward via the flexing elements 54C, 54D and rotate about their respective axes A_{52A}, A_{52C} to allow the second forming element 116 to pass by (see also FIGS. 5A and 14).

The track assembly 400 (see FIGS. 6 and 16) continues to support and align the mandrel assembly 100 with respect to the folding station 18, such that as the mandrel assembly 100 withdraws from the folding station 18 in the direction E, the front edge of the first side plate 102, which is collectively defined by the front edge 103A of the first main plate 103 and the front edge 150A of the first rail 150 in the illustrated example, is perpendicular to the first and second deck planes P₁, P₂; and the upper and lower edges of the first side plate 102, as respectively defined by the upper edge 103B of the first main plate 103 and the lower edge 150C of the first rail 150 in the illustrated example, are parallel to the first and second deck planes P₁, P₂. Although not visible, the front edge of the second side plate 104, which is collectively defined by the front edge 105A of the second main plate 105 and the front edge 152A of the second rail 152 in the illustrated example, is also perpendicular to the first and second deck planes P₁, P₂; and the upper and lower edges of the second side plate 104, as respectively defined by the upper edge 105B of the second main plate 105 and the lower edge 152C of the second rail 152, are also parallel to the first and second deck planes P₁, P₂ (see FIGS. 7, 8, and 14).

The apparatus for forming a tapered tray, as described herein, provides a configuration that can be used to form tapered trays of differing dimensions and/or degrees of taper with little or no changes to the configuration and with fewer moving parts that need to be replaced. Unlike conventional tray-forming equipment in which only the upper forming element pivots and the mandrel assembly enters the folding station at an angle, the mandrel assembly in accordance with the present disclosure advances into, and withdraws from, the folding station at an approximately 90 degree angle, with the flexing of the upper and horizontal rollers and the pivoting of the upper and lower forming elements allowing a consistent and substantially equal degree of taper to be formed on both sides of the tray at the same time. In addition, the upper and lower vertical rollers, which replace the single metal compression roller typically used in conventional tray-forming equipment, are formed from a softer polymer material that permits some degree of compression as the mandrel assembly and blank pass by. Thus, the apparatus in accordance with the present disclosure can accommodate, for example, blanks of differing thicknesses and can be used to form trays having different degrees of taper and/or depths.

While particular embodiments of the present invention have been illustrated and described, it should be understood that various changes and modifications may be made without departing from the spirit and scope of the invention. It is therefore intended to cover in the appended claims all such changes and modifications that are within the scope of this invention.

1. An apparatus comprising:
a mandrel assembly comprising:
a first side plate;
a second side plate spaced apart from the first side plate;
first and second bars coupled to and extending between the first and second side plates, the second bar being spaced apart from the first bar;
a first forming element pivotally coupled to the first bar and configured to rotate in a first direction by a first amount from a home position to a collapsed position; and
a second forming element pivotally coupled to the second bar and configured to rotate in a second direction by a second amount from a home position to a collapsed position, wherein the second direction is opposite the first direction; and
a folding station defining an opening that receives the mandrel assembly.

2. The apparatus of claim 1, wherein the second amount is substantially equal to the first amount.

3. The apparatus of claim 1, wherein:
the first forming element comprises a first main body and at least one first forming section that extends beyond the first main body; and
the second forming element comprises a second main body and at least one second forming section that extends beyond the second main body,
when the first and second forming elements are in the home position, front edges of the first and second side plates and the at least one first and second forming sections collectively define a first footprint, and the opening defined by the folding station comprises dimensions corresponding to the first footprint; and
when the first and second forming elements are in the collapsed position, front edges of the first and second side plates and the at least one first and second forming sections collectively define a second footprint that is smaller than the first footprint.

4. The apparatus of claim 3, wherein:
the at least one first and second forming sections extend beyond respective upper and lower edges of the first and second side plates by a first distance when the first and second forming elements are in the home position; and
the at least one first and second forming sections extend beyond the respective upper and lower edges of the first and second side plates by a second distance when the first and second forming elements are in the collapsed position, the second distance being less than the first distance.

5. The apparatus of claim 3, wherein the at least one first forming section comprises a first substantially planar outer edge and the at least one second forming section comprises a second substantially planar outer edge.

6. The apparatus of claim 5, wherein when the first and second outer forming elements are in the home position, the first and second substantially planar outer edges are substantially parallel with each other.

7. The apparatus of claim 1, wherein the mandrel assembly further comprises:
at least one first biasing element configured to bias the first forming element toward the home position; and
at least one second biasing element configured to bias the second forming element toward the home position.

8. The apparatus of claim 1, wherein the folding station comprises
at least one first deck section defining a first deck plane;
at least one second deck section spaced apart from the at least one first deck section and defining a second deck plane parallel with the first deck plane, wherein the first and second deck planes extend parallel to a longitudinal axis of the first and second forming elements;
at least one first horizontal roller associated with the at least one first deck section such that the at least one first horizontal roller extends beyond the first deck plane and is configured to contact the first forming element; and
at least one second horizontal roller associated with the at least one second deck section such that the at least one second horizontal roller extends beyond the second deck plane and is configured to contact the second forming element, wherein the at least one first and second horizontal roller each have a rotational axis parallel to the respective first and second deck planes.

9. The apparatus of claim 8, wherein the first side plate comprises a first front edge and the second side plate comprises a second front edge, and wherein the first and second front edges are substantially perpendicular to the first and second deck planes.

10. The apparatus of claim 8, wherein the at least one first horizontal roller is movably mounted with respect to the at least one first deck section such that the at least one first horizontal roller is configured to deflect in a direction that is substantially perpendicular to the first deck plane, and wherein the at least one second horizontal roller is movably mounted with respect to the at least one second deck section such that the at least one second horizontal roller is configured to deflect in a direction that is substantially perpendicular to the second deck plane.

11. The apparatus of claim 1, wherein the folding station comprises at least one first vertical roller and at least one second vertical roller, wherein the at least one second vertical roller is spaced apart from the at least one first vertical roller, and wherein a rotational axis of the at least one first and second vertical rollers is perpendicular to a longitudinal axis of the first and second forming elements.

12. The apparatus of claim 1, further comprising an actuator coupled to the mandrel assembly and configured to move the mandrel assembly relative to the folding station.

13. A method of forming a tapered tray from a blank, the blank comprising a bottom panel and first, second, third, and fourth side panels coupled to the bottom panel, the method comprising:
providing a mandrel assembly comprising a first forming element configured to rotate in a first direction and a second forming element configured to rotate in a second direction opposite the first direction, wherein the mandrel assembly comprises a first footprint substantially corresponding to at least one of a length and a width of the bottom panel;
advancing the mandrel assembly to a first position such that the mandrel assembly engages the bottom panel of the blank and moves the blank toward a folding station;
advancing the mandrel assembly to a second position within the folding station to fold the first and second side panels inward toward each other to a first folded position, wherein the first and second side panels are substantially perpendicular to the bottom panel in the first folded position;
advancing the mandrel assembly to a third position within the folding station to fold the first and second side panels further inward to a second folded position;
advancing the mandrel assembly to a fourth position within the folding station to couple the third and fourth side panels to the first and second side panels to form the tapered tray; and
withdrawing the mandrel assembly from the tapered tray, wherein the first and second forming elements rotate in the respective first and second directions as the mandrel assembly withdraws, such that the mandrel assembly comprises a second footprint that is smaller than the first footprint.

14. The method of claim 13, wherein an opening of the tapered tray is defined by outer edges of the first, second, third, and fourth side panels and comprises a length and a width, wherein one of the length or the width of the opening is less than the length or the width of the bottom panel, and wherein a length and a width of the second footprint of the mandrel substantially corresponds to, or is less than, the length and width of the opening.

15. The method of claim 13, wherein advancing the mandrel assembly to the second position comprises contacting the first side panel with at least one first deck section of the folding station and contacting the second side panel with at least one second deck section of the folding station such that the first and second side panels fold inward to the first folded position.

16. The method of claim 15, wherein the folding station further comprises at least one first horizontal roller associated with the at least one first deck section and extending beyond a first deck plane defined by the at least one first deck section, and at least one second horizontal roller associated with the at least one second deck section and extending beyond a second deck plane defined by the at least one second deck section, the first and second deck planes extending parallel to longitudinal axes of the first and second forming elements; and
wherein advancing the mandrel assembly to the third position comprises contacting the first side panel with the at least one first horizontal roller and contacting the second side panel with the at least one second horizontal roller, such that the first and second side panels fold inward to the second folded position.

17. The method of claim 13, wherein the mandrel assembly further comprises a first side plate and a second side plate, the second side plate being spaced apart from the first side plate, wherein the first and second forming elements extend between the first and second side plates, and wherein when the mandrel assembly advances into and withdraws from the folding station, front edges of the first and second side plates are substantially perpendicular to the first and second deck planes.

18. The method of claim 13, wherein when the first and second side panels are in the second folded position, the first side panel is positioned at a first inner angle of less than 90 degrees with respect to the bottom panel, and the second side panel is positioned at a second inner angle of less than 90 degrees with respect to the bottom panel.

19. The method of claim 18, wherein the first and second inner angles are substantially equal.

20. The method of claim 18, wherein the first and second inner angles are between about 85 and 87 degrees.
